(19) United States
(12) Patent Application Publication
(10) Pub. No.: US 2011/0285378 A1
(43) Pub. Date: Nov. 24, 2011

(54) DRIVE DEVICE

(76) Inventor: Shuji TAMAOKA, Kyoto (JP)

(21) Appl. No.: 13/102,426

(22) Filed: May 6, 2011

(30) Foreign Application Priority Data
May 18, 2010 (JP) 2010-114267

(51) Int. Cl. H02M 3/156

(52) U.S. Cl. 323/351

(57) ABSTRACT

When a drive signal that is a PWM input signal is small (when the drive duty component of the PWM drive signal is small), shoot-through (through state) between the upper transistor and lower transistor can occur when there is variation in the drive circuit or transistors. An upper switching device and lower switching device control current supply to a load, and an upper drive circuit and lower drive circuit respectively drive the upper switching device and lower switching device. The upper drive circuit has an input terminal that receives a control signal that turns the upper switching device on or off; an upper source circuit that SOURCE outputs a drive current to the control terminal of the upper switching device according to a first level or second level signal applied to the input terminal; an upper sink circuit that SINK outputs drive current to the control terminal of the upper switching device according to a second level or first level signal applied to the input terminal; an upper sink transistor that sinks capacitive current through the control terminal when the upper switching device is off; an upper interface circuit that generates a first input drive signal to the upper source circuit according to the input terminal signal, and a second input drive signal to the upper sink circuit or the upper sink transistor; and a selector that selectively supplies the second input drive signal to the upper sink circuit or the upper sink transistor based on a signal from the inverter. The lower drive circuit is identically configured.

### BACKGROUND OF THE INVENTION

(1) Field of the Invention

The present invention relates to a drive device for a switching device used in a semiconductor integrated circuit device, and relates more particularly to a drive device for driving a switching device to the control terminal of which a capacitive current flows during the off period of the switching device.

(2) Description of Related Art

A high-voltage half-bridge circuit that uses a switching device drive circuit according to the related art is shown in FIG. 4. Japanese Unexamined Patent Appl. Pub. JP-A-H03-3415 describes a related drive device.

This half-bridge circuit has a lower drive circuit DL that drives the lower transistor T2 of the high-voltage half-bridge circuit and a upper drive circuit DU that drives the upper transistor T1, and these upper and lower drive circuits DL and DU each have a first stage switch SW0 and second stage sink transistor M1 for turning the transistors T1 and T2 on and off while sinking the capacitive current from the control terminals of the transistors. The sink transistor M1 prevents one of the transistors T1 and T2 from turning on undesirably as a result of the capacitive current, and prevents variation in the output voltage of the half-bridge circuit from rising to such a high level that excessive electromagnetic interference is produced. This has the effect of preventing shoot-through and minimizing electromagnetic interference.

This is described further below, but shoot-through in a half-bridge circuit is described first with reference to FIG. 5A, FIG. 5B, FIG. 6A, and FIG. 6B.

Shoot-through refers to what happens when the upper transistor T1 and lower transistor T2 of the half-bridge circuit turn on simultaneously, and a strong current flows between the upper power supply (VM) connected to T1 and the lower power supply (GND) connected to T2, and is also referred to herein as a “through state.” The strong current flowing through T1 and T2 between VM and GND is also referred to herein as the “through current.”

Causes for shoot-through occurring when the load current is SOURCE output from the OUT terminal of the half-bridge circuit is described with reference to FIG. 5A and FIG. 5B.

FIG. 5A and FIG. 58 describe operation when load current is SOURCE output from the OUT terminal, which is the output of the half-bridge circuit, and to describe the operating states include a block diagram showing each block, the input/output signals of each block, the connection states of the load connected to the OUT terminal, and the flow of the load current, and a waveform timing chart of each input signal, output signal, and load current.

The block diagram shown in FIG. 5A is substantially the same as the half-bridge circuit using a drive circuit according to the related art shown in FIG. 4, except that the blocks not needed to described shoot-through are omitted.

The timing chart shown in FIG. 5B also assumes that the upper drive circuit DU and lower drive circuit DL have sufficient current capacity and can control current so that the slew rate of the output voltage of the OUT terminal can be controlled. This assumption is made to simplify describing the operation of the gate currents IGU and IGL from the gates, which are the control terminals of the upper transistor T1 and lower transistor T2 switching devices. This assumption is inconceivable in actual practice, however, which is why the drive circuit of the related art described in JP-A-H03-3415 was proposed.

The continuous cyclical operation of the half-bridge circuit from when the half-bridge circuit receives the drive signal of a cyclical input signal until the load current is SOURCE output from the OUT terminal is described in the block diagram in FIG. 5A and the timing chart in FIG. 5B. Because how the load current and the output voltage OUT of the OUT terminal are affected by this cyclical drive signal can be understood from the figures, further description thereof is omitted.

In order to describe the factors resulting in shoot-through (a through state) between transistors T1 and T2, description of the gate currents IGU and IGL in the cyclical operation of the half-bridge circuit is required and follows below.

The gate current IGU of the upper transistor T1 in the block diagram in FIG. 5A is described first.

The gate current IGU shown at (e) in the timing chart in FIG. 5B is the current that is SOURCE output to the gate of the upper transistor T1 so that the upper drive circuit DU sets the gate voltage GU of the upper transistor T1 HIGH at the rising edge of signal GUD, which is delayed delay time DT from the rising edge of the half-bridge circuit drive signal. Because the transistor T1 drives the OUT output when the half-bridge circuit SOURCE outputs the load current from the OUT terminal, the rising slew rate of the OUT terminal output voltage is determined by the gate current and the capacitance of the gate/drain capacity CT1 of transistor T1.

Similarly, the gate current IGU shown at (f) in the same timing chart is the current that is pulled from the gate of the transistor T1 for the upper drive circuit DU to set the gate voltage GU of the upper transistor T1 to LOW at the falling edge of signal GUD delayed delay time DT from the falling edge of the half-bridge circuit drive signal. Because transistor T1 drives the OUT output when the half-bridge circuit SOURCE outputs the load current from the OUT terminal output, the falling slew rate of the OUT terminal output voltage is determined by the gate current and the capacitance of the gate/drain capacity CT1 of transistor T1.

The gate current IGL of the lower transistor T2 shown in the block diagram in FIG. 5A is described next.

The gate current IGL shown at (a) in the timing chart in FIG. 5B is the current that is pulled from the gate of the transistor T2 for the lower drive circuit DL to set the gate voltage GL of the lower transistor T2 LOW by means of signal GLD, which drops from HIGH to LOW at the rising edge of the half-bridge circuit drive signal.

The gate current IGL shown at (b) in the same timing chart is the current that flows from the gate of the transistor T2 as a result of the output voltage OUT of the OUT terminal rising when the transistor T2 is off. This current is a capacitive current of which the current is determined by the slew rate of the rising edge of the output voltage OUT and the capacitance of the gate/drain capacity CT2 of the transistor T2. If the sink current capacity of the lower drive circuit DL to this current is low, the gate voltage GL of the transistor T2 swings to the HIGH side, and shoot-through may occur with through current flowing between transistors T1 and T2.

The gate current IGL at (c) in the same timing chart is the current that flows from the lower drive circuit DL to the gate of transistor T2 at the falling edge of the output voltage OUT of the OUT terminal when transistor T2 is off. This current is a capacitive current that is determined by the slew rate of the falling edge of the output voltage OUT and the capacitance of the gate/drain capacity CT2 of transistor T2. If the source current capacity of the lower drive circuit DL to this current drops, the gate voltage GL of the transistor T2 will drop below the GND level, but as a result through current will not flow between transistors T1 and T2.

The gate current IGL at (d) in the same timing chart is the current that the lower drive circuit DL SOURCE outputs to set the gate voltage GL of the transistor T2 HIGH at the rising edge of the signal GLD delayed twice the delay time DT from the falling edge of the half-bridge circuit drive signal.

Causes for shoot-through when the load current is SINK input to the OUT terminal output of the half-bridge circuit is described next using FIG. 6A and FIG. 6B.

FIG. 6A and FIG. 6B describe operation when the load current is SINK input to the OUT terminal, which is the output of the half-bridge circuit. As in FIG. 5A and FIG. 5B, to describe the operating states FIG. 6A and FIG. 6B include a block diagram showing each block, the input/output signals of each block, the connection states of the load connected to the OUT terminal, and the flow of the load current, and a waveform timing chart of each input signal, output signal, and load current.

The same omissions and assumptions regarding a half-bridge circuit using the drive circuit of the related art shown in FIG. 4 are made in FIG. 6A as in FIG. 5A, and further description thereof is the same as for FIG. 5A and is therefore omitted here.

Similarly to when the load current is SOURCE output from the OUT terminal, which is the output of the half-bridge circuit, in FIG. 5A, in order to describe the factors resulting in shoot-through (a through state) between transistors T1 and T2, description of the gate currents IGU and IGL in the cyclical operation of the half-bridge circuit is required and follows below.

The gate current IGL of the lower transistor T2 in the block diagram in FIG. 6A is described first. The gate current IGL shown at (g) in the timing chart in FIG. 6B is the current that the lower drive circuit DL draws from the gate of transistor T2 to set the gate voltage GL of the transistor T2 LOW by means of signal GLD, which drops from HIGH to LOW at the rising edge of the half-bridge circuit drive signal. Because transistor T2 drives the OUT output when the half-bridge circuit SINK inputs the load current to the OUT terminal output, the rising slew rate of the OUT terminal output voltage is determined by the gate current and the gate/drain capacity CT2 of transistor T2.

Likewise, the gate current IGL shown at (h) in the timing chart in FIG. 6B is the current that the lower drive circuit DL SOURCE outputs to set the gate voltage GL of the transistor T2 HIGH by means of the rising edge of signal GLD delayed twice the delay time DT from the falling edge of the half-bridge circuit drive signal. Because transistor T2 drives the OUT output when half-bridge circuit SINK inputs the load current to the OUT terminal output, the falling slew rate of the OUT terminal output voltage is determined by the gate current and the gate/drain capacity CT2 of transistor T2.

The gate current IGU of the transistor T1 shown in the block diagram in FIG. 6A is described next.

The gate current IGU shown at (i) in the timing chart in FIG. 6B is the current that flows from the upper drive circuit DU to the gate of transistor T1 when the output voltage OUT of the OUT terminal rises while the transistor T1 is off. This gate current is a capacitive current that is determined by the rising slew rate of the output voltage OUT and the capacitance of the capacity CT1 of transistor T1. If the source current capacity of the upper drive circuit DU is low relative to this gate current, the difference voltage GU-OUT of the gate voltage GU of the transistor T1 and the OUT terminal output voltage is less than 0 V, and through current therefore does not flow between transistors T1 and T2.

The gate current IGU shown at (j) in the same timing chart is the current that is SOURCE output to the gate of the upper transistor T1 so that the upper drive circuit DU sets the gate voltage GU of the upper transistor T1 HIGH at the rising edge of signal GUD, which is delayed delay time DT from the rising edge of the half-bridge circuit drive signal.

Similarly, the gate current IGU shown at (f) in the same timing chart is the current that is pulled from the gate of the transistor T1 for the upper drive circuit DU to set the gate voltage GU of the upper transistor T1 to LOW at the falling edge of signal GUD delayed delay time DT from the falling edge of the half-bridge circuit drive signal.

The gate current IGU shown at (j) in the same timing chart is the current that flows from the gate of transistor T1 to the upper drive circuit DU when the output voltage OUT of the OUT terminal falls while the transistor T1 is off. This current is a capacitive current that is determined by the rising slew rate of the output voltage OUT and the capacitance of the capacity CT1 of transistor T1. If the sink current capacity of the upper drive circuit DU to this current is low, the difference voltage GU-OUT of the gate voltage GU of transistor T1 and OUT terminal output voltage swings to the HIGH side, and shoot-through in which through current flows between transistors T1 and T2 could occur.

As described above, when load current is SOURCE output from the OUT terminal of the half-bridge circuit, the gate current IGL shown at (b) in FIG. 5B that flows from the gate of transistor T2 to the lower drive circuit DL becomes a problem because the output voltage OUT of the OUT terminal rises while transistor T2 is off. If the sink current capacity of the lower drive circuit DL is low, this current causes the gate voltage GL of transistor T2 to swing to the HIGH side, possibly resulting in shoot-through in which through current flows between the transistors T1 and T2.

When the load current is SINK input to the OUT terminal output of the half-bridge circuit, the gate current IGU at (l) in FIG. 6B flowing from the gate of transistor T1 to the upper drive circuit DU becomes a problem because the output voltage OUT of the OUT terminal falls while the transistor T1 is off. If the sink current capacity of the upper drive circuit DU is low, this current causes the gate voltage GU of transistor T1 to swing to the HIGH side, possibly resulting in shoot-through in which through current flows between the transistors T1 and T2.

Causes of shoot-through in a half-bridge circuit are as described above, and application of a half-bridge circuit using the drive circuit according to the related art to a case in which the load current is SOURCE output from the output terminal OUT in FIG. 5A and FIG. 5B to address these problems is considered next.

With the operating mechanism of the drive circuit according to the related art described above, the sink transistor M1 of the drive circuit with a high sink current capacity operates when the AND of the following two conditions is true.

(1) Input signal GLD of the lower drive circuit DL is LOW;

(2) (Input signal GUD of the upper drive circuit DU is LOW);

(3) Gate voltage GL of the lower transistor T2 is less than threshold voltage VthL, which is set lower than the operating voltage VGSon of transistor T2.

(For the upper drive circuit DU, the gate voltage GU-OUT of the upper transistor T1 is lower than the threshold voltage VthL, which is set lower than the operating voltage VGSon of transistor T1.)

As a result, because the capacitive gate current IGL of transistor T2 at (b) in FIG. 58 is sinked by the sink transistor M1 of the lower drive circuit DL, and the gate voltage GL of transistor T2 is held to a sufficiently LOW level, shoot-through (through state) between transistors T1 and T2 does not occur even at (b) in FIG. 5B.

The sink transistor M1 of the upper drive circuit DU does not operate, however, because conditions (1) and (2) above are not satisfied. As a result, the gate current IGU of the upper drive circuit DU that determines the slew rate of the output terminal voltage OUT of the half-bridge circuit shown in FIG. 5A can be set according to the desired slew rate without being affected by the sink transistor M1 of the upper drive circuit DU while the output terminal voltage OUT changes between VM and 0 V.

Application of the half-bridge circuit using the drive circuit according to the related art to SINK input of the load current to the output terminal OUT in FIG. 6A and FIG. 6B is described next.

Similarly to when the load current is SOURCE output from the output terminal OUT as described above, because the capacitive gate current IGU of transistor T1 at (l) in FIG. 6B is sinked by the sink transistor M1 of the upper drive circuit DU, and the difference voltage GU-OUT of the gate voltage GU and output voltage OUT of transistor T1 is held to a sufficiently LOW level, shoot-through (through state) between transistors T1 and T2 also does not occur in the case of (l) in FIG. 6B.

The sink transistor M1 of the lower drive circuit DL does not operate, however, because conditions (1) and (2) above are not satisfied. As a result, the gate current IGL of the lower drive circuit DL that determines the slew rate of the output terminal voltage OUT of the half-bridge circuit shown in FIG. 6A can be set according to the desired slew rate without being affected by the sink transistor M1 of the lower drive circuit DL while the output terminal voltage OUT changes between VM and 0 V.

A half-bridge circuit using a drive circuit according to the related art can therefore set the slew rate of the output voltage as desired and can thereby prevent significant electromagnetic interference. In addition, shoot-through (through state) between the upper transistor T1 and the lower transistor T2 can be prevented.

An example of a prior art driver circuit is shown in Japanese Patent Publication JP-A-H03-3415.

However, when the drive signal, which is the PWM input signal of the half-bridge circuit, is weak (that is, the drive duty component of the PWM drive signal is small) in the half-bridge circuit using a drive circuit according to the related art, shoot-through (through state) can occur between the upper transistor T1 and lower transistor T2. This problem is described below.

This problem is described below with reference to FIG. 7A, FIG. 7B, FIG. 7C and FIG. 8A, FIG. 8B, FIG. 8C.

FIG. 7A, FIG. 7B, FIG. 7C relate to the possibility of shoot-through caused by the gate current IGL of the lower transistor T2 at (b) in FIG. 5A and FIG. 5B, and show only the relevant parts. More particularly, FIG. 7A shows when the load current is output from the OUT terminal. FIG. 7B shows when the load current is high and VGSon of transistor T2 is high but T2 does not turn on and a through mode (shoot-through) does not occur because the current sink stage transistor M2 works and sinks IGL. FIG. 7C shows when the load current is low, VGSon of T2 is low, and transistor T2 starts turning on and a through mode (shoot-through) occurs because IGL flows before M2 turns on.

FIG. 8A, FIG. 8B, FIG. 8C similarly relate to the possibility of shoot-through caused by the gate current IGU of the transistor T1 at (l) in FIG. 6A and FIG. 6B, and show only the relevant parts.

More particularly, FIG. 8A shows when the load current is output from the OUT terminal. FIG. 8B shows when the load current is high and VGSon of transistor T1 is high but T1 does not turn on and a through mode (shoot-through) does not occur because the current sink stage transistor M1 works and sinks IGU. FIG. 8C shows when the load current is low, VGSon of T1 is low, and transistor T1 starts turning on and a through mode (shoot-through) occurs because IGU flows before M1 turns on.

While not shown in the figures, FIG. 7A to FIG. 8C assume that the drive duty component of the half-bridge circuit drive signal is small, that is, that the pulse width of the HIGH period of the drive signal in FIG. 5B and FIG. 6B is small. As a result, the delay time DT is also assumed to be short.

The problem of the drive circuit according to the related art is described next using FIG. 7A, FIG. 7B, and FIG. 7C, which relate to the possibility of shoot-through due to the gate current IGL of the lower transistor T2 at (b) in FIG. 5B.

The effect of the technology described in the foregoing related art is achieved when transistor T2 is off, transistor T1 changes from off to on, and the output voltage of the OUT terminal rises when the load current is output from the OUT terminal as shown in FIG. 7A.

In this case as shown in FIG. 7B, if the threshold voltage VthL and delay time DT of the drive circuit according to the related art are set appropriately relative to the characteristics of transistors T1 and T2, the sink transistor M1 operates appropriately and shoot-through (through state) in which transistors T1 and T2 are simultaneously on does not occur, and the electromagnetic interference level can also be minimized by appropriately setting the output voltage slew rate of the OUT terminal.

As described above, sink transistor M1 is on when GLD=L and GL<VthL in FIG. 7B.

However, with the drive circuit according to the related art, when the load current of the load driven by the transistors T1 and T2 changes, and the operating voltage VGSon that switches the transistors T1 and T2 on/off changes, the transistor T1 starts the on operation and the output voltage of the OUT terminal rises before the sink transistor M1 operates as shown in FIG. 7C, and as a result the gate current IGL flows from CT2 to the gate of transistor T2, transistor T2 goes from off to on, and shoot-through (through state) results.

Shoot-through (through state) as shown in FIG. 7C can also occur with the drive circuit according to the related art when the delay time DT of signal GLD and signal GUD varies, or when the parasitic gate-source or gate-drain capacitance of the transistors T1 and T2 varies.

Likewise, the effect of the technology according to the related art is achieved when the load current is pulled from the OUT terminal as shown in FIG. 8A when transistor T2 changes from off to on and the output voltage of the OUT terminal falls.

In this case, too, as shown in FIG. 8B, if the threshold voltage VthL and delay time DT of the drive circuit according to the related art are set appropriately relative to the characteristics of transistors T1 and T2, the sink transistor M1 operates appropriately and shoot-through (through state) in which transistors T1 and T2 are simultaneously on does not occur, and the electromagnetic interference level can also be minimized by appropriately setting the output voltage slew rate of the OUT terminal.

As described above, sink transistor M1 is on when GUD=L and GU<VthL in FIG. 8B.

However, with the drive circuit according to the related art, when the load current of the load driven by the transistors T1 and T2 changes, and the operating voltage VGSon that switches the transistors T1 and T2 on/off changes, the transistor T2 starts the on operation and the output voltage of the OUT terminal falls before the sink transistor M1 operates as shown in FIG. 8C, the gate current IGU flows from CT1 to the gate of transistor T1, transistor T1 goes from off to on, and shoot-through (through state) results.

Shoot-through (through state) as shown in F. 8C can also occur with the drive circuit according to the related art when the delay rime DT of signal GLD and signal GUD varies, or when the parasitic gate-source or gate-drain capacitance of the transistors T1 and T2 varies.

As described above, when the drive signal, which is the PWM input signal of the half-bridge circuit, is small (when the drive duty component of the PWM drive signal is small) with the half-bridge circuit using the drive circuit according to the related art, the delay time DT between the input signal GUD of the upper drive circuit and the input signal GSD of the lower drive circuit must be short. As a result, there is a possibility of shoot-through (through state) between the upper transistor T1 and the lower transistor T2 when there is variation in the load current of the drive circuit, the operating voltage VGSon, the delay time DT, or the parasitic gate-source or gate-drain capacitance of the transistors T1 and T2.

### BRIEF SUMMARY OF THE INVENTION

The present invention is directed to solving the problem of a half-bridge circuit using the drive circuit according to the related art, and an object of the invention is to provide a drive circuit for a half-bridge circuit that can prevent shoot-through (through state) between the upper transistor T1 and lower transistor T2, desirably set the slew rate of the output voltage, and optimize the electromagnetic interference level when there is variation in the load current of the drive circuit, the operating voltage VGSon, the delay time DT, or the parasitic gate-source or gate-drain capacitance of the transistors T1 and T2 even when the drive signal, which is the PWM input signal of the half-bridge circuit, is small (when the drive duty component of the PWM drive signal is small).

Another object of the invention is to provide a drive method for an output circuit that can desirably set the slew rate of the output voltage, optimize the electromagnetic interference level, and prevent shoot-through (through state) when the drive circuit of the invention and a drive direction detection circuit that controls the drive circuit according to another aspect of the invention is applied to an half-bridge circuit, an H bridge, a 3-phase inverter circuit, or other application.

A first aspect of the invention is a drive circuit that drives a switching device having a control terminal to which capacitive current flows when the switching device is off, including: an input terminal that receives a control signal that turns the switching device on or off; a source circuit that SOURCE outputs drive current to the control terminal of the switching device according to a HIGH or LOW level signal applied to the input terminal; a sink circuit that SINK outputs drive current to the control terminal of the switching device according to a LOW level or HIGH level signal applied to the input terminal; a current sink transistor M1 that sinks capacitive current through the control terminal when the switching device is off; an interface circuit that generates an input drive signal to the source circuit according to the input terminal signal, and an input drive signal to the sink circuit or the sink transistor M1; a selector that selects whether to output the input drive signal to the sink circuit or the sink transistor as the input drive signal to the sink circuit or to the sink transistor M1; and an input terminal that receives a selection signal to the selector controlling this selection operation.

In a drive circuit according to another aspect of the invention, the selector sends a signal turning the sink transistor M1 off when the input drive signal is output to the sink circuit and the sink circuit is driven, or sends a signal turning the sink circuit off or sends a signal continuously holding the sink circuit on when'the input drive signal is output to the control terminal of the sink transistor M1 and the transistor is driven.

In a drive circuit according to another aspect of the invention, the source current of the source circuit and the sink current of the sink circuit apply suitable drive current to the control terminal of the switching device, and suitably set the output voltage slew rate of a half-bridge circuit, H bridge circuit, or 3-phase inverter circuit composed of a plurality of switching devices and the drive circuit.

The source circuit and sink circuit according to this aspect of the invention can desirably set the output voltage slew rate of a half-bridge circuit, H bridge circuit, or 3-phase inverter circuit using the drive circuit of the invention, and can thus optimize the electromagnetic interference level.

In a drive circuit according to another aspect of the invention, the current capacity of the current sink transistor M1 is sufficient, and the capacitive current flowing to the control terminal of the switching device can be sufficiently sinked.

With the sink transistor M1 according to this aspect of the invention, shoot-through (through state) between the switching devices no longer occurs even if capacitive current flows to the control terminal of the switching device when the switching device is off in a half-bridge circuit, H bridge circuit, or 3-phase inverter circuit using the drive circuit of the invention.

A drive direction detection circuit according to a second aspect of the invention that controls the selector in the drive circuit according to the first aspect of the invention is a drive direction detection circuit that is used with a half-bridge circuit which is composed of: two switching devices T1 and T2 to the control terminals of which capacitive current flows when the switching devices are off; two drive circuits DU and DL that respectively drive the switching devices T1 and T2; a drive control circuit that signal processes the input drive signal generates an upper drive signal GUD that is input to the upper drive circuit DU to drive the upper switching device T1, and generates a lower drive signal GLD that is input to the lower drive circuit DL to drive the lower switching device T2; a level shifter that sends the upper drive signal GUD to the upper drive circuit DU; and an inverter that inverts the polarity of the input signal to the selector of the upper drive circuit DU and the input signal to the selector of the lower drive circuit DL. The drive direction detection circuit generates direction signals used as selection signals applied to the selectors of the upper drive circuit DU and lower drive circuit DL based on the output voltage of the half-bridge circuit, the drive signal that is the input signal to the drive control circuit of the half-bridge circuit, the upper drive signal GUD input to the upper drive circuit DU, and the lower drive signal GLD input to the lower drive circuit DL.

A first aspect of a drive direction detection circuit according to the invention includes: a direction detection circuit that outputs either or both a direction detection signal that is generated from a detection signal indicating if the output voltage of the half-bridge circuit exceeds a certain threshold voltage, the drive signal, and the upper drive signal GUD, and a direction detection signal that is generated from a detection signal indicating if the output voltage of the half-bridge circuit exceeds a certain threshold voltage, the drive signal, and the lower drive signal GLD, HIGH or LOW according to the directional polarity indicated by the direction detection signal; a differential pulse circuit having a falling output terminal that outputs a pulse with a certain pulse width when the direction detection circuit output signal goes from HIGH to LOW, and a rising output terminal that outputs a pulse of a certain pulse width when the direction detection circuit output signal goes from LOW to HIGH; a pulse adder that, when there are plural direction detection circuit outputs or there are plural differential pulse circuits corresponding to plural direction signal outputs identical to the direction detection circuit, combines the falling output terminals of the plural differential pulse circuits and the rising output terminals of the plural differential pulse circuits at a single falling output terminal and a single rising output terminal; and a SR flip-flop that receives the pulses from the rising output terminal and the falling output terminal of the pulse adder as a set pulse/reset pulse or a reset pulse/set pulse, and outputs a HIGH or LOW signal.

In another aspect of the invention, the drive direction detection circuit has a direction detection circuit that includes a hysteresis comparator, and at least one of: an output terminal that outputs a HIGH or LOW polarity signal according to the HIGH or LOW polarity of the lower drive signal GLD when the output voltage of the half-bridge circuit exceeds the HIGH threshold voltage of the hysteresis comparator according to the HIGH or LOW polarity of the drive signal, and an output terminal that outputs a HIGH or LOW polarity signal according to the HIGH or LOW polarity of the upper drive signal GUD when the output voltage of the half-bridge circuit is less than the LOW threshold voltage of the hysteresis comparator according to the other polarity of the drive signal.

When the second aspect of a drive direction detection circuit described above is used, whether the load current of the load connected to the output terminal of the half-bridge circuit is being discharged or pulled can be determined when the output voltage of the half-bridge circuit rises or falls, and the direction signal that is the result of this flow direction decision (drive direction detection result) can be sent as an appropriate selection signal to the selector of the drive circuit according to the first aspect of the invention. The two drive circuits of the half-bridge circuit use these direction signals to control operation of sink transistors that can desirably sufficiently sink capacitive current flowing to the control terminal of the switching device, thereby preventing shoot-through (through state), and can adjust the slew rate of the output voltage of the half-bridge circuit to a desirable level.

A third aspect of a drive direction detection circuit that controls the drive circuit according to the first aspect of the invention is a drive direction detection circuit that is used with a half-bridge circuit which is composed of: two switching devices T1 and T2 to the control terminals of which capacitive current flows when the switching devices are off; two drive circuits DU and DL that respectively drive the switching devices T1 and T2; a drive control circuit that signal processes the input drive signal generates an upper drive signal GUD that is input to the upper drive circuit DU to drive the upper switching device T1, and generates a lower drive signal GLD that is input to the lower drive circuit DL to drive the lower switching device T2; a level shifter that sends the upper drive signal GUD to the upper drive circuit DU; and an inverter that inverts the polarity of the input signal to the selector of the upper drive circuit DU and the input signal to the selector of the lower drive circuit DL. The drive direction detection circuit generates direction signals used as selection signals applied to the selectors of the upper drive circuit DU and lower drive circuit DL of the half-bridge circuit based on the control terminal voltage of switching device T1 or T2 (that is, the output voltage of the upper drive circuit DU or the lower drive circuit DL), and the input drive signal that is input to the upper drive circuit DU or lower drive circuit DL.

A third aspect of a drive direction detection circuit according to the invention includes: a direction detection circuit that outputs either or both a direction detection signal that is generated from a detection signal indicating if the control terminal voltage of the switching device (that is, the output voltage of the drive circuit) exceeds a certain threshold voltage, and a rising edge signal of a delayed input drive signal that is the input drive signal delayed a certain time, and a direction detection signal that is generated from a detection signal indicating if the control terminal voltage of the switching device exceeds a certain threshold voltage, and a falling edge signal of a delayed input drive signal that is the input drive signal delayed a certain time, HIGH or LOW according to the directional polarity indicated by the direction detection signal; a differential pulse circuit having a falling output terminal that outputs a pulse with a certain pulse width when the direction detection circuit output signal goes from HIGH to LOW, and a rising output terminal that outputs a pulse of a certain pulse width when the direction detection circuit output signal goes from LOW to HIGH; a pulse adder that, when there are plural direction detection circuit outputs or there are plural differential pulse circuits corresponding to plural direction signal outputs identical to the direction detection circuit, combines the falling output terminals of the plural differential pulse circuits and the rising output terminals of the plural differential pulse circuits at a single falling output terminal and a single rising output terminal; and a SR flip-flop that receives the pulses from the rising output terminal and the falling output terminal of the pulse adder as a set pulse/reset pulse or a reset pulse/set pulse, and outputs a HIGH or LOW signal.

In another aspect of the invention, the drive direction detection circuit has a direction detection circuit that includes a hysteresis comparator, and at least one of: an output terminal that outputs a signal of HIGH or LOW polarity according to whether or not the control terminal voltage of switching device T1 or T2 exceeds the HIGH threshold voltage of the hysteresis comparator at the rising edge or falling edge of a delayed input drive signal, which is the input drive signal delayed a certain time; and an output terminal that outputs a signal of HIGH or LOW polarity according to whether or not the control terminal voltage of switching device T1 or T2 is less than the LOW threshold voltage of the hysteresis comparator at the falling edge or rising edge of a delayed input drive signal, which is the input drive signal delayed a certain time.

Similarly to the drive direction detection circuit according to the second aspect of the invention, when the foregoing third aspect of a drive direction detection circuit described above is used, whether the load current of the load connected to the output terminal of the half-bridge circuit is being discharged or pulled can be determined when the input drive signal of the drive circuit in the half-bridge circuit rises or falls, and the direction signal that is the result of this flow direction decision (drive direction detection result) can be sent as an appropriate selection signal to the selector of the drive circuit according to the first aspect of the invention. The two drive circuits of the half-bridge circuit use these direction signals to control operation of sink transistors that can desirably sufficiently sink capacitive current flowing to the control terminal of the switching device, thereby preventing shoot-through (through state), and can adjust the slew rate of the output voltage of the half-bridge circuit to a desirable level.

### Effect of the Invention

A drive circuit according to the invention is used in a half-bridge circuit that is rendered with a switching device to the control terminal of which capacitive current flows while the switching device is off, and by applying the drive circuit of the invention in this half-bridge circuit, the slew rate of the output voltage of the half-bridge circuit can be set desirably and the electromagnetic interference level can be optimized.

Applying the drive circuit of the invention to the foregoing half-bridge circuit enables rendering a half-bridge circuit in which shoot-through (through state) between the upper transistor T1 and lower transistor T2 does not occur when the drive signal, which is a PWM input signal, of the half-bridge circuit is small (when the drive duty rate of the PWM drive signal is small), even if there is variation in the drive circuit load current, the VGSon voltage, delay time DT, or parasitic capacitance between the gate-source or gate-drain of the transistors T1 and T2.

Using the drive circuit of the invention and a drive direction detection circuit that sends a signal identifying the drive direction of the half-bridge circuit to a selection signal input terminal of a selector in the drive circuit, a control method can be provided for an output circuit that can desirably adjust the output voltage slew rate, optimize electromagnetic interference, and prevent shoot-through in an H bridge circuit or 3-phase inverter circuit as well as in the half-bridge circuit.

Other objects and attainments together with a fuller understanding of the invention will become apparent and appreciated by referring to the following description and claims taken in conjunction with the accompanying drawings.

### BRIEF DESCRIPTION OF THE SEVERAL VIEWS OF THE DRAWINGS

FIG. 1 is a circuit diagram of a first embodiment of a drive device using a drive circuit according to the invention.

FIG. 2A is a circuit diagram showing an operating state of the drive circuit shown in FIG. 1.

FIG. 2B is a waveform diagram for the drive circuit in FIG. 2A.

FIG. 3A is a circuit diagram showing an operating state of the drive circuit shown in FIG. 1.

FIG. 3B is a waveform diagram for the drive circuit in FIG. 3A.

FIG. 4 is a circuit diagram of a high-voltage half-bridge circuit using a drive circuit according to the related art.

FIG. 5A is a circuit diagram describing shoot-through in the half-bridge circuit according to the related art.

FIG. 5B is a waveform diagram describing shoot-through in the half-bridge circuit according to the related art.

FIG. 6A is a circuit diagram describing shoot-through in the half-bridge circuit according to the related art.

FIG. 6B is a waveform diagram describing shoot-through in the half-bridge circuit according to the related art.

FIG. 7A is a circuit diagram of a high-voltage half-bridge circuit using the drive circuit according to the related art.

FIG. 7B is a waveform diagram of the high-voltage half-bridge circuit using the drive circuit according to the related art.

FIG. 7C is a waveform diagram of the high-voltage half-bridge circuit using the drive circuit according to the related art.

FIG. 8A is a circuit diagram of a high-voltage half-bridge circuit using the drive circuit according to the related art.

FIG. 8B is a waveform diagram of the high-voltage half-bridge circuit using the drive circuit according to the related art.

FIG. 8C is a waveform diagram of the high-voltage half-bridge circuit using the drive circuit according to the related art.

FIG. 9 is a circuit diagram of a second embodiment of a drive device using a drive circuit and drive direction detection circuit 100.

FIG. 10 is a circuit diagram of the second embodiment showing the drive direction detection circuit 100 in detail.

FIG. 11 is a waveform diagram of the circuits in the second embodiment.

FIG. 12 is a circuit diagram of a third embodiment of a drive device using a drive circuit and drive direction' detection circuit 200.

FIG. 13 is a circuit diagram of a fourth embodiment of a drive device using a drive circuit and drive direction detection circuit 300.

FIG. 14 is a circuit diagram of the fourth embodiment showing the drive direction detection circuit 300 in detail.

FIG. 15 is a waveform diagram of the circuits in the fourth embodiment.

FIG. 16 is a circuit diagram of a fifth embodiment of a drive device using a drive circuit and drive direction detection circuit 400.

FIG. 17 is a circuit diagram of a sixth embodiment using a drive circuit, drive direction detection circuit 300, and drive direction detection circuit 300H.

FIG. 18 is a circuit diagram of the sixth embodiment showing the drive direction detection circuit 300 and drive direction detection circuit 300H in detail.

FIG. 19 is a waveform diagram of the circuits in the sixth embodiment.

FIG. 20 is a circuit diagram of a seventh embodiment of a drive device using the drive circuit of the invention to render an H bridge.

FIG. 21A is a circuit diagram of the input signal direction detection circuit shown in FIG. 20.

FIG. 21B is a waveform diagram of the input signal direction detection circuit shown in FIG. 20.

FIG. 21C is a waveform diagram of the input signal direction detection circuit shown in FIG. 20.

FIG. 22A is a circuit diagram of a variation of the input signal direction detection circuit shown in FIG. 20.

FIG. 22B is a waveform diagram of the variation of the input signal direction detection circuit shown in FIG. 20.

FIG. 22C is a waveform diagram of the variation of the input signal direction detection circuit shown in FIG. 20.

FIG. 23A is a circuit diagram of an input signal direction detection circuit for a 3-phase inverter.

FIG. 23B is a waveform diagram for the input signal direction detection circuit for a 3-phase inverter.

FIG. 24 is a circuit diagram of a variation of an input signal direction detection circuit for a 3-phase inverter.

FIG. 25 is a circuit diagram of an eighth embodiment of a drive device rendered with an H bridge using a drive circuit and the drive direction detection circuit 100.

FIG. 26 is a circuit diagram of a variation of the eighth embodiment of a drive device rendered with an H bridge using a drive circuit and the drive direction detection circuit 100.

FIG. 27 is a circuit diagram of a ninth embodiment of a drive device rendered with an H bridge using a drive circuit and the drive direction detection circuit 200.

FIG. 28 is a circuit diagram of a tenth embodiment of a drive device rendered with an H bridge using a drive circuit and the drive direction detection circuit 300.

FIG. 29 is a circuit diagram of a variation of the tenth embodiment of a drive device rendered with an H bridge using a drive circuit and the drive direction detection circuit 300.

FIG. 30 is a circuit diagram of an eleventh embodiment of a drive device rendered with an H bridge using a drive circuit and the drive direction detection circuit 400.

FIG. 31 is a circuit diagram of a twelfth embodiment of a drive device rendered with an H bridge using a drive circuit, the drive direction detection circuit 300, and the drive direction detection circuit 300H.

FIG. 32 is a circuit diagram of a drive device applying the seventh embodiment to a 3-phase inverter.

FIG. 33 is a circuit diagram of another drive device applying the seventh embodiment to a 3-phase inverter.

FIG. 34 is a circuit diagram of a drive device applying the eighth embodiment to a 3-phase inverter.

FIG. 35 is a circuit diagram of another drive device applying the eighth embodiment to a 3-phase inverter.

FIG. 36 is a circuit diagram of a drive device applying the ninth embodiment to a 3-phase inverter.

FIG. 37 is a circuit diagram of another drive device applying the ninth embodiment to a 3-phase inverter.

FIG. 38 is a circuit diagram of drive device applying the tenth embodiment to a 3-phase inverter.

FIG. 39 is a circuit diagram of another drive device applying the tenth embodiment to a 3-phase inverter.

FIG. 40 is a circuit diagram of a drive device applying the eleventh embodiment to a 3-phase inverter.

FIG. 41 is a circuit diagram of another drive device applying the eleventh embodiment to a 3-phase inverter.

FIG. 42 is a circuit diagram of a drive device applying the twelfth embodiment to a 3-phase inverter.

FIG. 43 is a circuit diagram of another drive device applying the twelfth embodiment to a 3-phase inverter.

### DETAILED DESCRIPTION OF THE INVENTION

### Embodiment 1

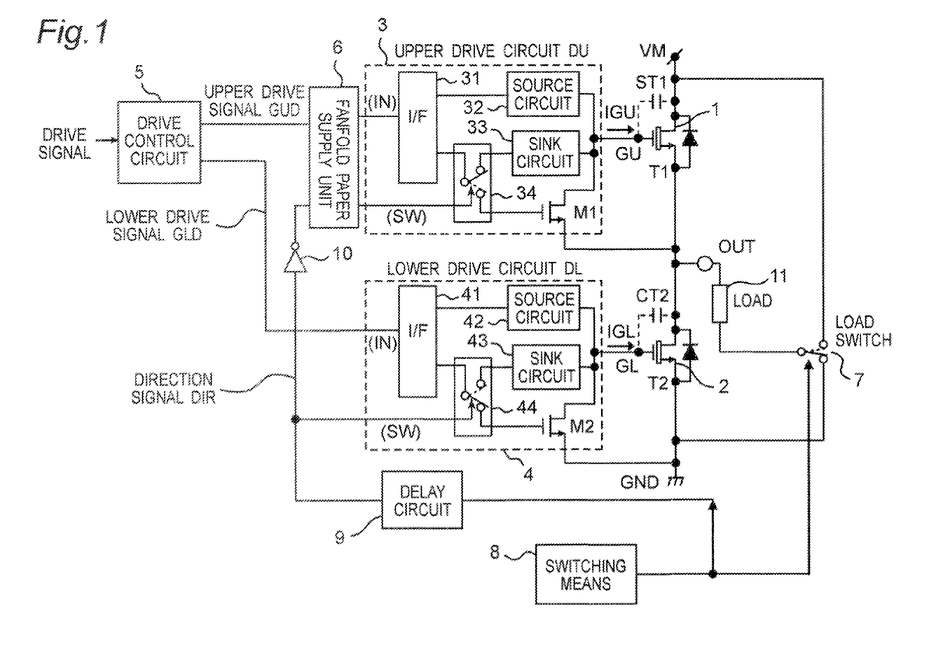

FIG. 1 describes the configuration of a drive device according to a preferred embodiment of the invention. A first embodiment of a half-bridge circuit as an example of a drive device according to the invention is described below with reference to FIG. 1.

FIG. 1 shows a half-bridge circuit using a drive circuit according to the first embodiment of the invention.

The half-bridge circuit includes: switching device T1 and switching device T2, which in this embodiment of the invention are two power MOSFET transistors to which a capacitive current flows to the control terminal, that is, the gate, thereof during the off period; an upper drive circuit DU and a lower drive circuit DL that respectively drive the transistors T1 and T2; a drive control circuit 5 that signal processes the drive signal that drives the half-bridge circuit, and generates an upper drive signal GUD that is input to the upper drive circuit DU that drives the upper transistor T1, and a lower drive signal GLD that is input to the lower drive circuit DL that drives the lower transistor T2; a level shifter 6 that relays the GUD signal to the upper drive circuit DU; a load switch 7 that switches the connection of the other end of the load 11 that is connected to the output terminal OUT of the half-bridge circuit to the power supply VM or to GND; a switching means 8 that controls switching the load switch 7; and an inverter 10 that inverts the polarity of the input signal to the selector 34 of the upper drive circuit DU, and the input signal to the selector 44 of the lower drive circuit DL.

Drive circuit DU includes an interface 31, source circuit 32, sink circuit 33, selector 34, and sink transistor M1.

Signals for the source circuit and signals for the sink circuit are output from the interface 31, and the sink circuit signals are supplied to the sink circuit 33 or the sink transistor M1 as selected by the selector 34. The sink transistor M1 is a transistor that sinks capacitive current through the control terminal while the switching device is OFF.

Drive circuit DL includes an interface 41, source circuit 42, sink circuit 43, selector 44, and sink transistor M2.

Signals for the source circuit and signals for the sink circuit are output from the interface 41, and the sink circuit signals are supplied to the sink circuit 43 or the sink transistor M2 as selected by the selector 44. The sink transistor M2 is a transistor that sinks capacitive current through the control terminal while the switching device is OFF.

The control signal output from the switching means 8 controls switching the load switch 7 to connect the other end of the load connected to the output terminal OUT of he half-bridge circuit to the power supply VM or to GND, and is used as the direction signal DIR that functions as the selection signal of the selectors 34, 44 of the upper drive circuit DU and lower drive circuit DL.

A first control signal output from the switching means 8 switches the load switch 7 to connect in the direction indicated by the dotted line, and the selectors 34, 44 to connect in the directions indicated by the dotted lines. As a result, the other end of the load 11 is connected to power supply VM, sink transistor M1 is selected in the upper drive circuit DU, and sink circuit 43 is selected in the lower drive circuit DL.

A second control signal output from the switching means 8 switches the load switch 7 to connect in the direction indicated by the solid line, and the selectors 34, 44 to connect in the directions indicated by the solid lines. As a result, the other end of the load 11 is connected to GND, sink circuit 33 is selected in the upper drive circuit DU, and sink transistor M2 is selected in the lower drive circuit DL.

The first control signal and second control signal from the switching means 8 switch at a specific frequency F1. This frequency F1 is independent of the frequency F2 at which the upper drive signal GUD and lower drive signal GLD switch, and frequency F1 is a frequency that is several decimal places lower than frequency F2. As a result, the first control signal from the switching means 8 causes switching device T1 and switching device T2 to repeatedly turn on and off on the order of several hundred to several thousand time while current flows forward to the load 11.

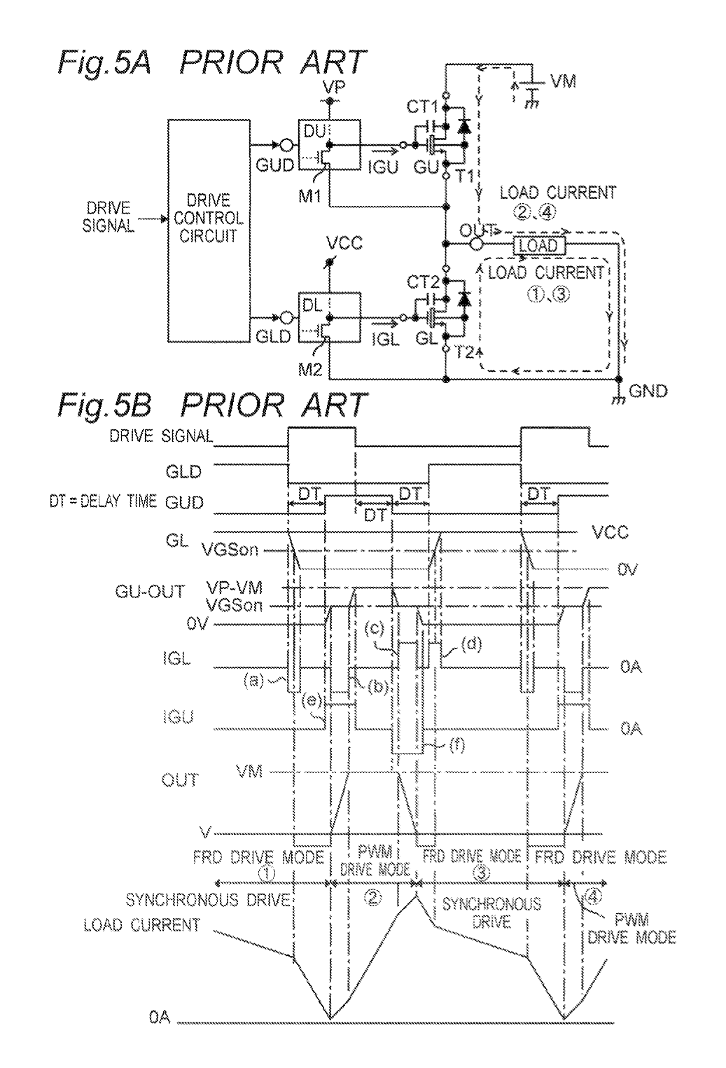

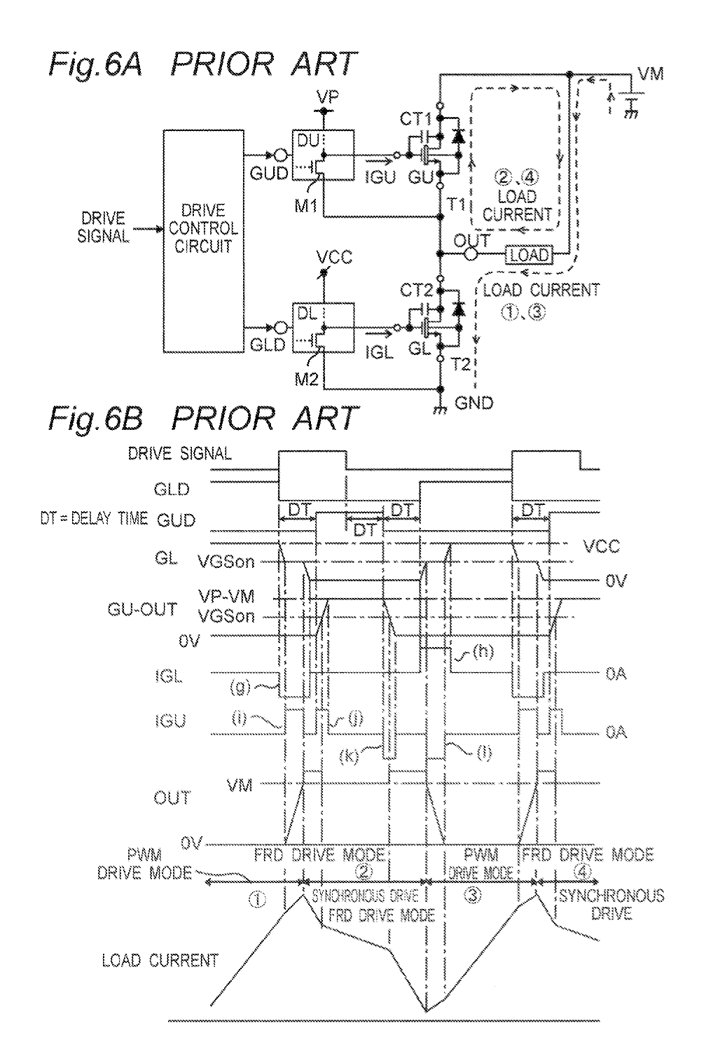

In order to supply AC current of the desired frequency to the load 11, the switching means 8 repeatedly alternately outputs the first control signal and second control signal. When current flows from the load 11 to GND, the load switch 7 is connected as shown by the solid line, and load current flows as indicated by the dotted line in FIG. 5A. When current flows from the load 11 to the power supply VM side, the load switch 7 is connected as shown by the dotted line, and load current flows as indicated by the dotted line in FIG. 6A.

Note that a delay circuit 9 with a suitable delay time may be inserted according to the type of load 11 between the output terminal of the switching means 8 and the input terminal of the inverter 10 and the input terminal of the selector 44 in the lower drive circuit DL. This is to compensate for the delay between when the load switch switches and the direction in which the load current flows switches when the load switch changes position when the load is an inductive load with an inductive component, and the delay time of the delay circuit can be set appropriately according to the inductance component and the resistance component of the load.

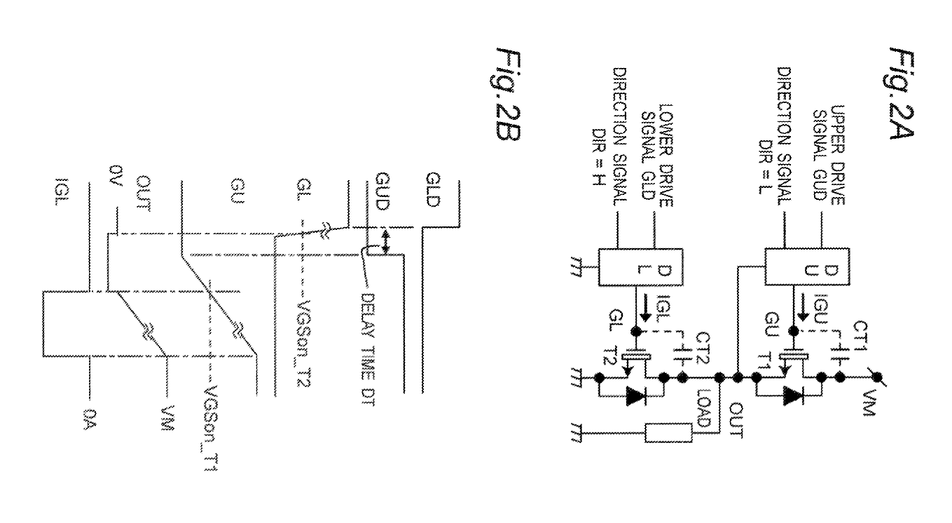

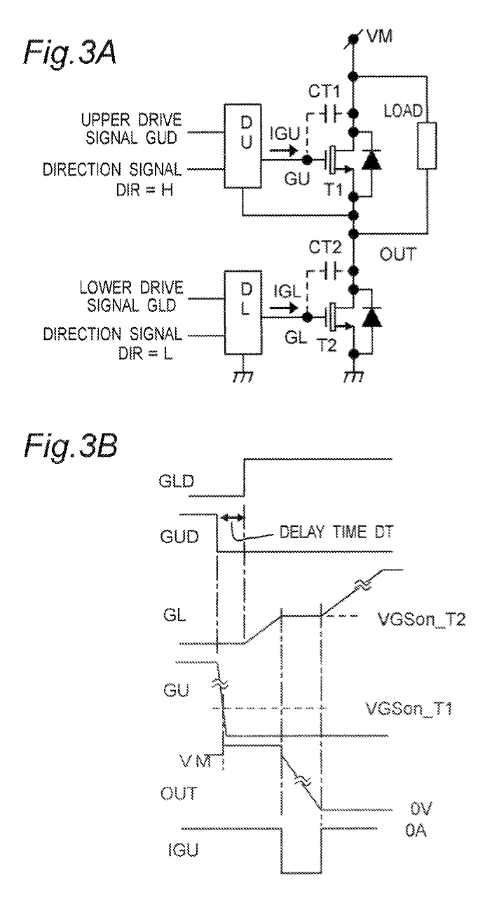

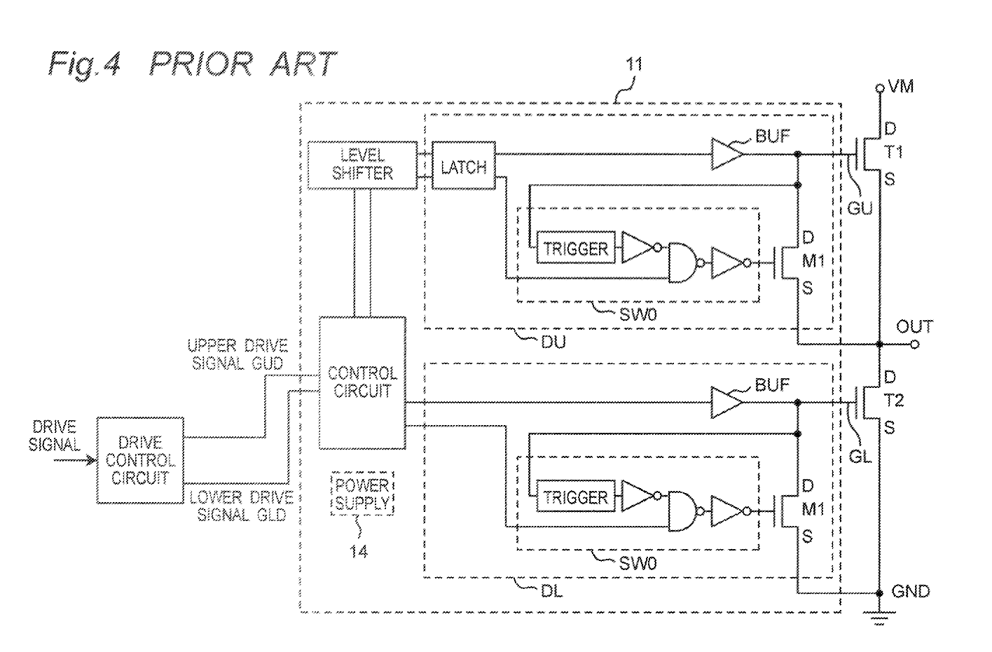

In the half-bridge circuit using a drive circuit according to the invention shown in FIG. 1, even when the duty rate of the drive signal, which is a PWM input signal, is low, the possibility of shoot-through (through state) occurring between the upper transistor T1 and lower transistor T2 can be greatly improved, the slew rate of the output circuit can be set appropriately, and the electromagnetic interference level can be minimized. This is described with reference to FIG. to FIG. 2A, FIG. 2B and FIG. 3A, FIG. 3B.

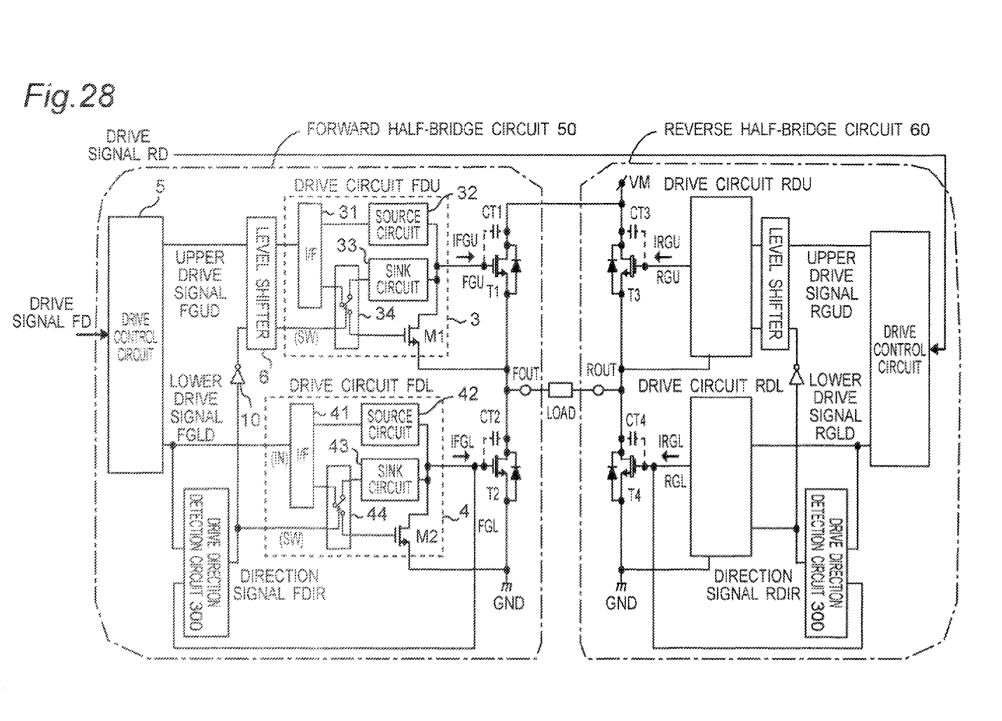

FIG. 2A and FIG. 2B describe operation when the load current from the OUT terminal, which is the output of the half-bridge circuit, is SOURCE output. FIG. 2A shows the case when the other end of the load goes to GND, that is, when the load current is discharged from the OUT terminal. FIG. 28 shows a state in which the transistor T2 does not turn on and a through mode (shoot-through) does not occur when the current sink transistor M2 operates according to the change in the low drive signal GLD from HIGH to LOW and sinks the gate current IGL.

FIG. 2A is a block diagram showing the connections of the drive signals GUD and GLD of the upper drive circuit DU and lower drive circuit DL, the direction signals DIR input to the drive circuits, and the connection of the load that is connected to the OUT terminal, in order to describe the operating states.

When load current is SOURCE output from the OUT terminal, the other end of the load connected to the OUT terminal is connected to GND by the switching means 8, the direction signal DIR input to the lower drive circuit DL goes HIGH, and the direction signal DIR input to the upper drive circuit DU goes LOW as a result of the inverter 10 shown in FIG. 1. Note that the polarity of the direction signals input to the two drive circuits may be the opposite of the foregoing. In this case it is important that the selector 34 of the upper drive circuit DU operates the sink circuit 33 and turns the sink transistor M1 off, and that the direction signals DIR control the upper and lower drive circuits DU and DL so that sink transistor M1 is operated notwithstanding whether the selector 44 of the lower drive circuit DL operates sink circuit 43. This is further described below.

From the foregoing description using FIG. 5A of the behavior of the gate current IGU of the upper transistor T1 and the gate current IGL of the lower transistor T2 when load current is SOURCE output from the OUT terminal output of the half-bridge circuit, the following two facts are known when load current is SOURCE output from the OUT terminal output of the half-bridge circuit.

1. The gate current IGU that is supplied from the upper drive circuit DU to the gate of transistor T1 to produce SOURCE output and the gate current IGU that is supplied by SINK input to the gate of the upper transistor T1 are what determine the rising and the falling slew rates of the output voltage of the OUT terminal.

2. The reason the capacitive current flowing to the gate of the lower transistor T2 causes shoot-through (through state) between the upper transistor T1 and the lower transistor T2 is because the current sink capacity of the lower drive circuit DL is low.

Therefore, when load current is SOURCE output from the OUT terminal that is the output of the half-bridge circuit, the upper drive circuit DU always holds the sink transistor M1 off and the source circuit and sink circuit output or input the gate current IGU at the desired level so that the rising and falling slew rates of the OUT terminal output voltage are decided. We also know that because the rising and the falling slew rates of the OUT terminal output voltage are not dependent on the gate current of the lower transistor T2, the lower drive circuit DL can simply always operate the sink transistor M2 when the transistor T2 is turned off so that shoot-through is not caused by capacitive current.

Because the direction of the load current is generally determined from the connection status of the other end of the load, the drive circuit according to the invention uses the control signal output from the switching means 8, which controls switching the load switch 7 to connect the other end of the load to the power supply VM or to GND, as a direction signal DIR, and sets the output signal of the switching means 8 and the load switch so that when the other end of the load 11 is connected to GND the sink circuit 33 is selected and operates in the upper drive circuit DU, and the sink transistor M2 is selected and operates in the lower drive circuit DL. As a result, the invention can desirably set the slew rate of the output voltage of the half-bridge circuit, and can prevent shoot-through.

As described above, a delay circuit 9 with an appropriate delay time may be disposed between the output terminal of the switching means 8 and the input terminal of the inverter 10 and the input terminal of the selector 44 in the lower drive circuit DL. This is to compensate for the delay between when the load switch switches and the direction in which the load current flows switches when the load switch 7 changes position when the load 11 is an inductive load with an inductive component, and the delay time of the delay circuit 9 can be set appropriately according to the inductance component and the resistance component of the load.

However, because whether the direction of the load current changed from the SOURCE output to the SINK input at the correct timing cannot be known with only the delay circuit 9, a direction detection circuit that detects the change in the direction of the load current may be used to detect the direction of the load current and based thereon send the direction signal DIR to the upper and lower drive circuits DU and DL. This detection method is described in another embodiment of the invention below.

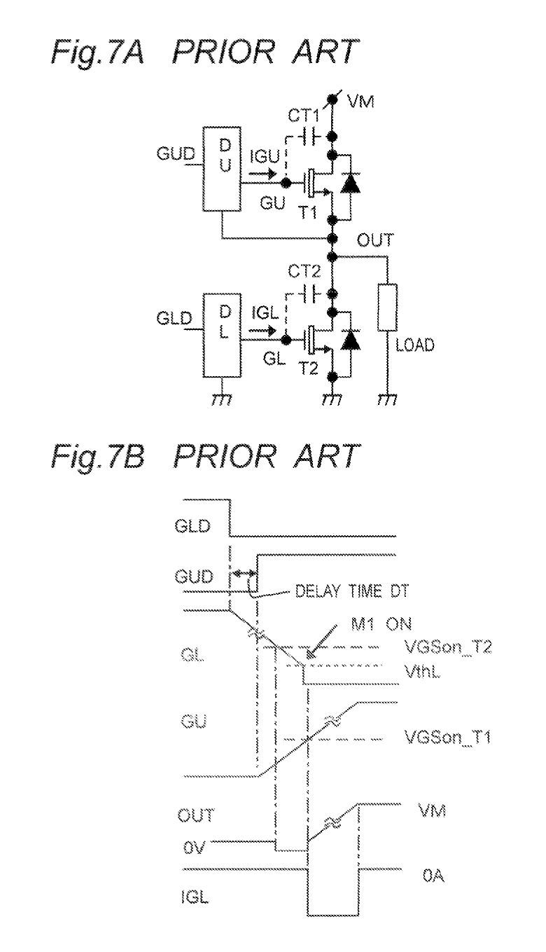

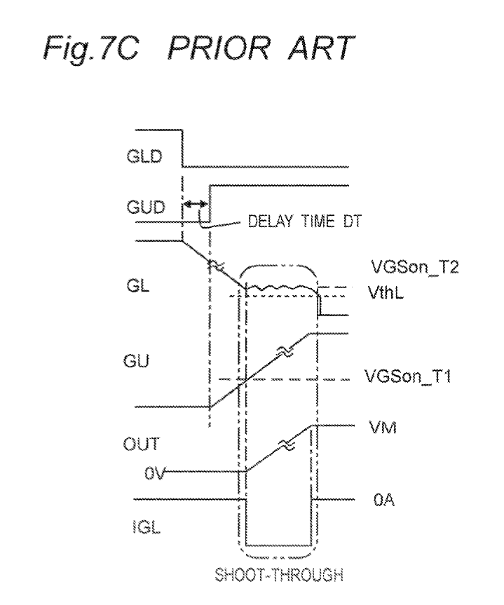

FIG. 2B is an operating waveform diagram of the drive circuit according to the invention corresponding to FIG. 7C that was used to describe the problem with the drive circuit according to the related art. As will be understood from FIG. 2B, shoot-through can be prevented even when the operating voltage VGSon of the upper transistor T1 is low because the transition of the gate voltage GL of the lower transistor T2 from HIGH to LOW is sharp due to the high sink capacity of the sink transistor M1.

FIG. 3A and FIG. 3B describe the operation when the OUT terminal that is the output of the half-bridge circuit sinks (draws) the load current. FIG. 3A shows the case when the other end of the load is connected to VM, that is, when the load current is drawn from the OUT terminal. FIG. 3B shows the state when transistor T1 does not turn on and a through mode (shoot-through) does not occur when the current sink transistor M1 operates and sinks the gate current IGU in response to the upper drive signal GUD changing from HIGH to LOW.

FIG. 3A is a block diagram showing the connections of the drive signals GUD and GLD of the upper drive circuit DU and lower drive circuit DL, the direction signals DIR input to the drive circuits, and the connection of the load that is connected to the OUT terminal, in order to describe the operating states.

When the OUT terminal draws the load current, the other end of the load 11 connected to the OUT terminal is connected to power supply VM by the switching means 8 shown in FIG. 1, the direction signal DIR input to the lower drive circuit DL goes LOW, and the direction signal input to the upper drive circuit DU goes HIGH due to the inverter shown in FIG. 1. Note that the polarity of the direction signals input to the two drive circuits may be the opposite of the foregoing. In this case it is important that the direction signals DIR control the upper and lower drive circuits DU and DL so that the selector 44 of the lower drive circuit DL operates the sink circuit 43 and turns the sink transistor M2 off, and the selector 34 of the upper drive circuit DU operates sink transistor M1 whether it operates or turns the sink circuit 33 off. This is further described below.

From the foregoing description using FIG. 6A and FIG. 6B of the behavior of the gate current IGU of the upper transistor T1 and the gate current IGL of the lower transistor T2 when the OUT terminal output of the half-bridge circuit draws load current, the following two facts are known when the OUT terminal output of the half-bridge circuit draws load current.

3. The gate current IGL that is SOURCE output to the gate and the gate current IGL that is SINK input to the gate of the lower transistor T2 from the lower drive circuit DL are what determine the rising and the falling slew rates of the output voltage of the OUT terminal.

4. The reason the capacitive current flowing to the gate of the upper transistor T1 causes shoot-through (through state) between the upper transistor T1 and the lower transistor T2 is because the current sink capacity of the upper drive circuit DU is low.

Therefore, when load current is SINK input to the OUT terminal that is the output of the half-bridge circuit, the lower drive circuit DL always holds the sink transistor M1 off and the source circuit and sink circuit output the gate current IGL at the desired level so that the rising and falling slew rates of the OUT terminal output voltage are decided. We also know that because the rising and falling slew rates of the OUT terminal output voltage are not dependent on the gate current of the upper transistor T1, the upper drive circuit DU can simply always operate the sink transistor M1 when the transistor T1 is turned off so that shoot-through is not caused by capacitive current.

Because the direction of the load current is generally determined from the connection status of the other end of the load, the drive circuit according to the invention uses the control signal output from the switching means 8, which controls switching the load switch 7 to connect the other end of the load to the power supply VM or to GND, as a direction signal DIR, and sets the output signal of the switching means 8 and the load switch so that when the other end of the load is connected to power supply VM, the sink circuit 33 is selected and operates in the lower drive circuit DL, and the sink transistor M1 is selected and operates in the upper drive circuit DU.

As a result, the invention can desirably set the slew rate of the output voltage of the half-bridge circuit, and can prevent shoot-through.

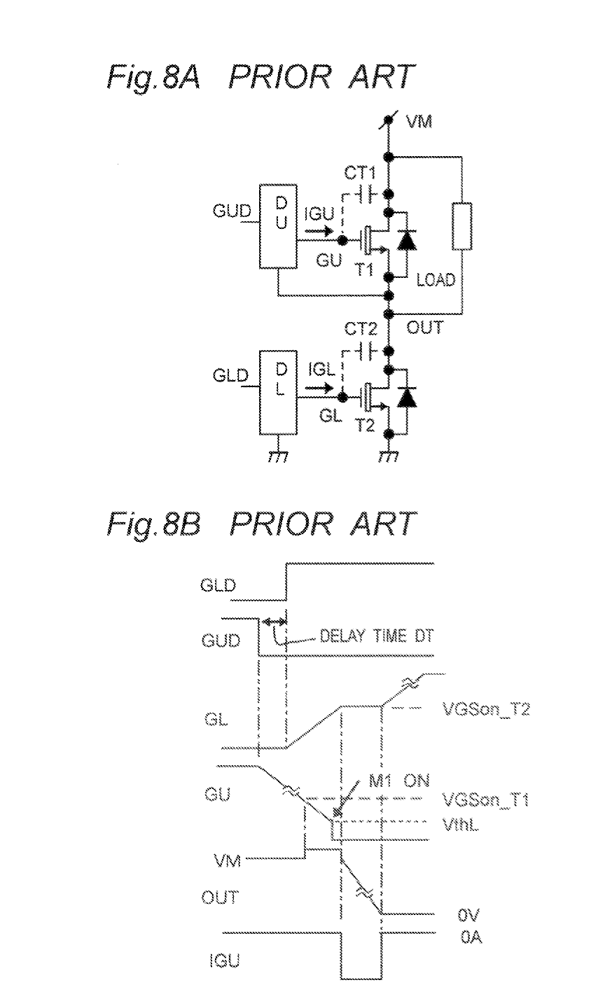

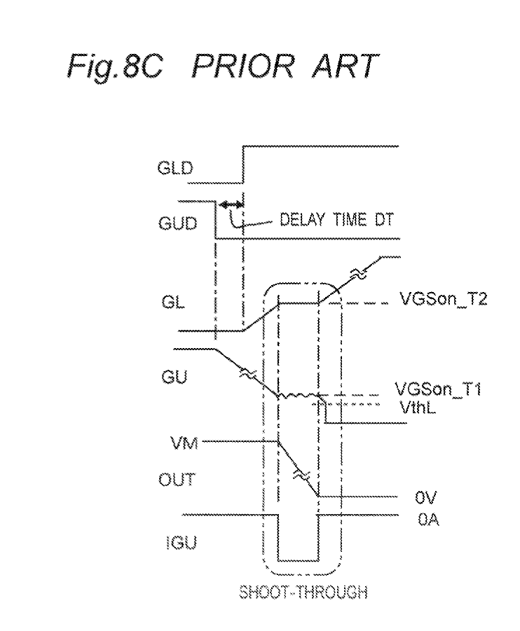

FIG. 3B is an operating waveform diagram of the drive circuit according to the invention corresponding to FIG. 8C that was used to describe the problem with the drive circuit according to the related art. As will be understood from FIG. 3B, shoot-through can be prevented even when the operating voltage VGSon of the lower transistor T2 is low because the transition of the gate voltage GU of the upper transistor T1 from HIGH to LOW is sharp due to the high sink capacity of the sink transistor M1.

In a half-bridge circuit using the drive circuit according to the invention shown in FIG. 1, the possibility of shoot-through (through state) between the upper transistor T1 and lower transistor T2 occurring can be greatly improved, the slew rate of the output circuit can be set appropriately, and electromagnetic interference can be minimized when the drive signal, which is the PWM input signal of the half-bridge circuit, is small (when the drive duty rate of the PWM drive signal is low), and when there is variation in the load current of the drive circuit, the operating voltage VGSon, the delay time DT, or the capacitance between the gate-source or gate-drain of the transistors T1 and T2.

### Embodiment 2

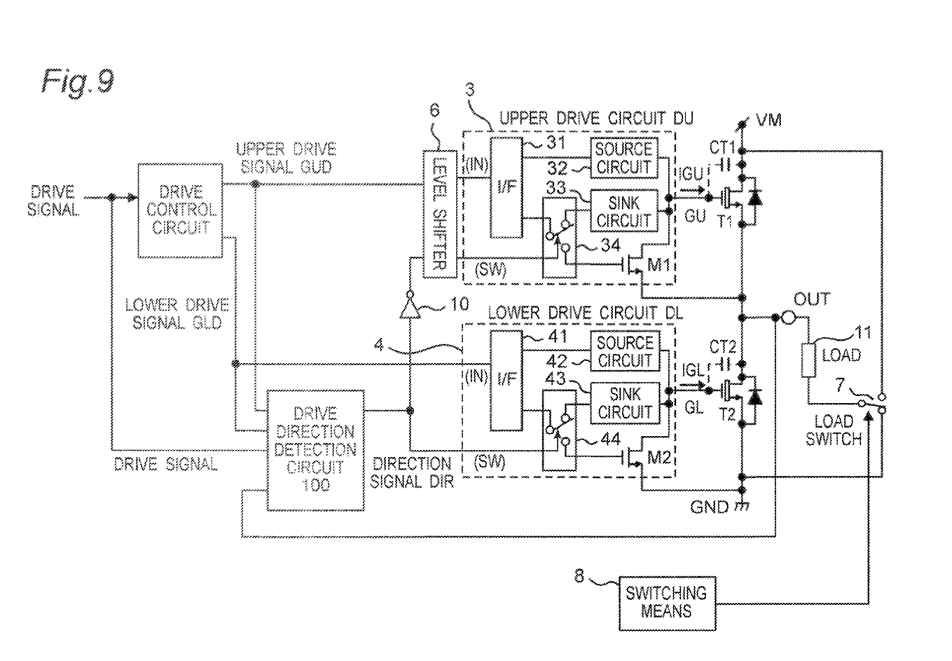

FIG. 9 shows the configuration of a second embodiment of the invention using the drive circuit according to the first embodiment and a drive direction detection circuit 100. The operation of the second embodiment is described below.

FIG. 9 shows a half-bridge circuit using the drive circuit according to the first embodiment and a drive direction detection circuit 100.

The half-bridge circuit includes: switching devices T1 and T2, which in this embodiment of the invention are two power MOSFET transistors to which a capacitive current flows to the control terminal, that is, the gate, thereof during the off period; an upper drive circuit DU and a lower drive circuit DL that respectively drive the transistors T1 and T2; a drive control circuit 5 that signal processes the drive signal that drives the half-bridge circuit, and generates an upper drive signal GUD that is input to the upper drive circuit DU that drives the upper transistor T1, and a lower drive signal GLD that is input to the lower drive circuit DL that drives the lower transistor T2; a level shifter 6 that relays the GUD signal to the upper drive circuit DU; a load switch 7 that switches the connection of the other end of the load 11 that is connected to the output terminal OUT of the half-bridge output circuit to the power supply VM or to GND; a switching means 8 that controls switching the load switch 7; an inverter 10 that inverts the polarity of the input signal to the selector 34 of the upper drive circuit DU, and the input signal to the selector 44 of the lower drive circuit DL; and a drive direction detection circuit 100.

The half-bridge circuit according to the second embodiment of the invention is substantially the same as the first embodiment, and differs from the first embodiment in the addition of the drive direction detection circuit 100.

The direction of current flowing to the load 11 is generally determined by the connection state of the other end of the load 11, but when the load 11 is an inductive load with an inductance component, switching the direction of flow of the load current when the load switch 7 switches is delayed from when the load switch 7 changes position. The drive direction detection circuit 100 is used to accurately detect this change in the load current.

The drive direction detection circuit 100 detects the direction of the load current of the load 11 connected to the output terminal OUT of the half-bridge circuit from the output voltage and drive signal of the output terminal OUT of the half-bridge circuit, the upper drive signal GUD and the lower drive signal GLD, and outputs a direction signal DIR that is HIGH or LOW according to the directional polarity. The lower drive circuit DL directly detects the direction signal DIR, and the upper drive circuit DU detects the direction signal DIR through the inverter 10 and level shifter 6, and the drive circuits of the lower drive circuit DL and upper drive circuit DU select sink circuit 33, 43, or selector 34, 44, by means of the respective selector 34, 44. By applying the drive direction detection circuit 100 to the half-bridge circuit, the slew rate of the output voltage of the half-bridge circuit can be appropriately set, and shoot-through (through state) can be prevented, even when the load of the half-bridge circuit is an inductive load with an inductance component. Note that the drive direction detection circuit 100 gets signals from the output terminal OUT of the half-bridge circuit downstream from the switching device T1 or T2, but could receive signals from the upstream side of the switching device T1 or T2, such as from the gate of switching device T1 or T2. Note that downstream and upstream as used herein refer to the direction in signals are passed in the system.

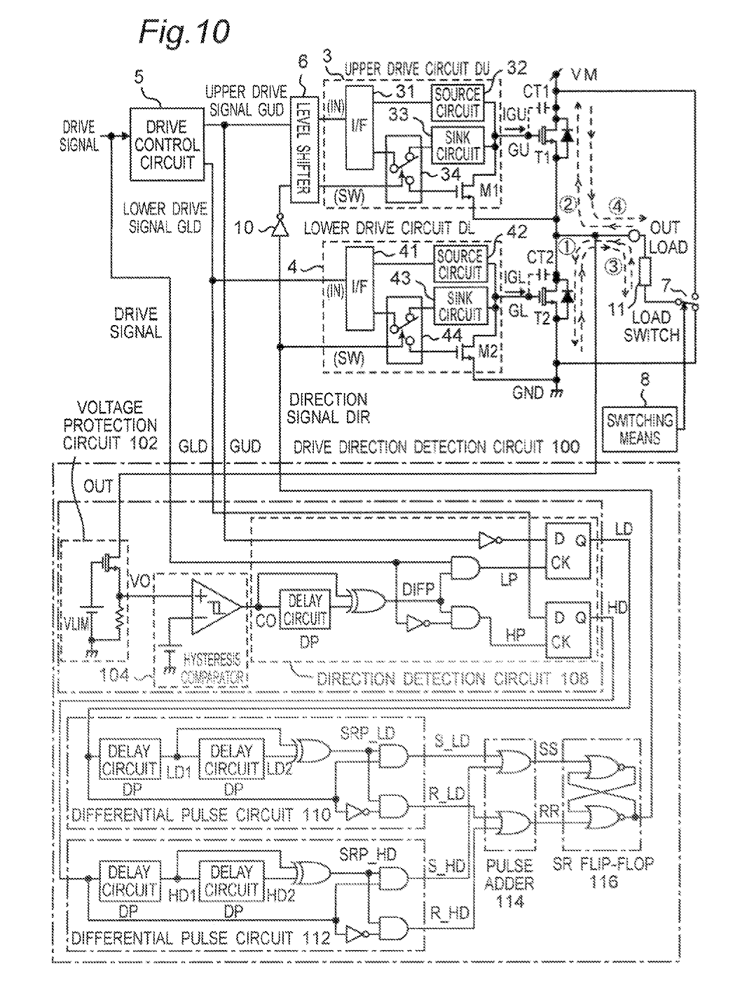

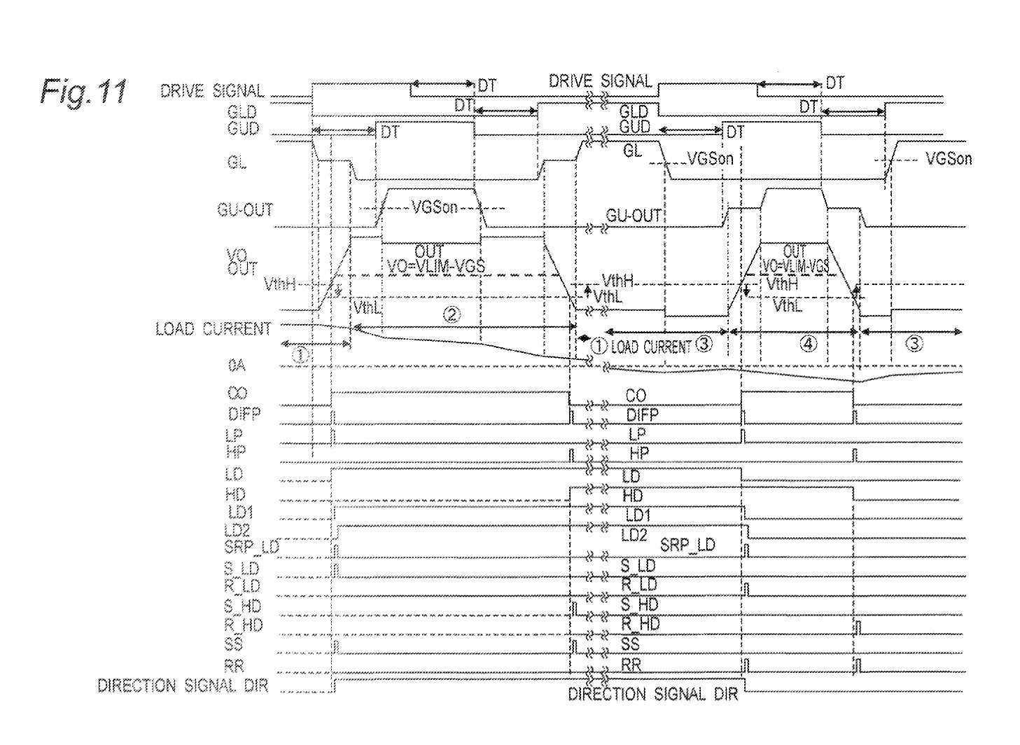

Operation of the drive direction detection circuit 100 in the second embodiment of the invention is described next with reference to FIG. 10 and FIG. 11. FIG. 10 is a block diagram showing in detail the configuration of the drive direction detection circuit 100 of the second embodiment shown in FIG. 9. FIG. 11 is a timing chart of the signals shown in FIG. 10.

The drive direction detection circuit 100 in the second embodiment of the invention includes a voltage protection circuit 102, a hysteresis comparator 104, a direction detection circuit 108, a differential pulse circuit 110, a differential pulse circuit 112, a pulse adder 114, and a flip-flop 116.

The voltage protection circuit 102 receives the output voltage OUT of the half-bridge circuit. The hysteresis comparator 104 compares the output voltage VO from the voltage protection circuit 102 with threshold voltages VthH and VthL.

The direction detection circuit 108 outputs a direction detection signal LD based on the upper drive signal GUD when the output voltage VO exceeds the threshold voltage VthH, and outputs a direction detection signal HD based on the output signal CO and drive signal of the hysteresis comparator 104 and the lower drive signal GLD when the output voltage VO goes below the threshold voltage VthL.

The differential pulse circuit 110 has a falling output terminal R_LD that outputs a pulse of a specific width when the output signal LD of the direction detection circuit 108 goes from HIGH to LOW, and a rising output terminal S_LD that outputs a pulse of a specific width when the output signal LD of the direction detection circuit 108 goes from LOW to HIGH.

The differential pulse circuit 112 has a falling output terminal R_HD that outputs a pulse of a specific width when the output signal HD of the direction detection circuit 108 goes from HIGH to LOW, and a rising output terminal S_HD that outputs a pulse of a specific width when the output signal HD of the direction detection circuit 108 goes from LOW to HIGH.

The pulse adder 114 outputs the OR of the falling output terminals R_LD and R_HD of the differential pulse circuits 110 and 112 from falling output terminal RR, and outputs the OR of the rising output terminals S_LD, S_HD of the differential pulse circuits 110, 112 from rising output terminal SS.

The flip-flop 116 receives the pulses from the falling output terminal RR and rising output terminal SS of the pulse adder as a set pulse/reset pulse or a reset pulse/set pulse, and outputs a HIGH or LOW signal.

Note that when there are plural differential pulse circuits according to whether there are plural direction detection circuit 108 outputs or there are plural direction signal outputs identical to the direction detection circuit, the pulse adder 114 is a pulse adder that combines each of the falling output terminals of the plural direction detection circuits and the rising output terminals of the plural direction detection circuits at single respective falling output terminals and rising output terminals.

The direction detection circuit 108 receives the output voltage OUT of the bridge circuit through voltage protection circuit 102 as output voltage VO. The voltage protection circuit 102 is a voltage protection clamping circuit provided in anticipation of the supply voltage of the power supply VM for supplying power to the half-bridge circuit being greater than the power supply of the drive direction detection circuit 100. If the output voltage OUT is less than a clamping voltage (VLIM-VGS), the output voltage VO of the voltage protection circuit 102 is substantially equal to the OUT voltage, and if the output voltage OUT is greater than or equal to the clamping voltage, the output voltage VO goes to VLIM-VGS.

When the drive signal is HIGH, the direction detection circuit 108 outputs direction detection signal LD, which is the inverse polarity of the upper drive signal GUD from when the output voltage VO exceeds the threshold voltage VthH of the hysteresis comparator 104.

When the drive signal is LOW, the direction detection circuit 108 outputs direction detection signal HD, which is the same polarity as the lower drive signal GLD from when the output voltage VO goes below the threshold voltage VthH of the hysteresis comparator 104.

Whether the output terminal OUT of the half-bridge circuit is SOURCE outputting or SINK inputting the load current can be determined as a result of the direction detection circuit outputting direction detection signals HD and LD as described above.

This is described in the timing chart in FIG. 11. The left side in FIG. 11 shows when the load current is SINK input to the OUT terminal, and the right side in FIG. 11 shows when the load current is SOURCE output from the OUT terminal. The drive signal, upper drive signal GUD, lower drive signal GLD, the gate voltage GU-OUT of transistor T1, the gate voltage GL of transistor T2, and the output voltage OUT (VO) are shown separately in FIG. 11 for the load currents (1), (2), (3), and (4) in FIG. 10 (each denoted by the numeral within a circle in the figure).

Based on the timing chart of these signal waveforms and the foregoing operating description of the direction detection circuit 108, it can be determined that if the direction signals LD and HD change from LOW to HIGH, the load current is SINK input to the output terminal OUT of the half-bridge circuit, and if the direction signals LD and HD change from HIGH to LOW, the load current is SOURCE output [input? sic?] to the output terminal OUT of the half-bridge circuit.

Note that direction signal LD is the direction detection signal when the half-bridge circuit output OUT rises, and direction signal HD is the direction detection signal when the half-bridge circuit output OUT falls. This means that the direction detection circuit 108 has two direction detection circuits. These two direction detection circuits detect the direction of the load current at different times on the time base.

The drive direction detection circuit 100 according to the second embodiment of the invention must operate at the appropriate time and output the direction signal DIR when the polarity of the output signals from the two detection circuit signals LD and HD change.

By rendering the differential pulse circuit, pulse adder, and SR flip-flop as shown in FIG. 10, the change in the polarity of the two detection circuit signals LD and HD can be appropriately processed and the direction signal DIR output.

As a result, when the load of the half-bridge circuit is an inductive load with an inductance component, a half-bridge circuit using the drive circuit according to the first embodiment of the invention and the drive direction detection circuit 100 can appropriately detect the direction of the load current, desirably set the slew rate of the output voltage of the half-bridge circuit, and prevent shoot-through (through state) whenever the direction of the load current of this inductive load changes.

### Embodiment 3

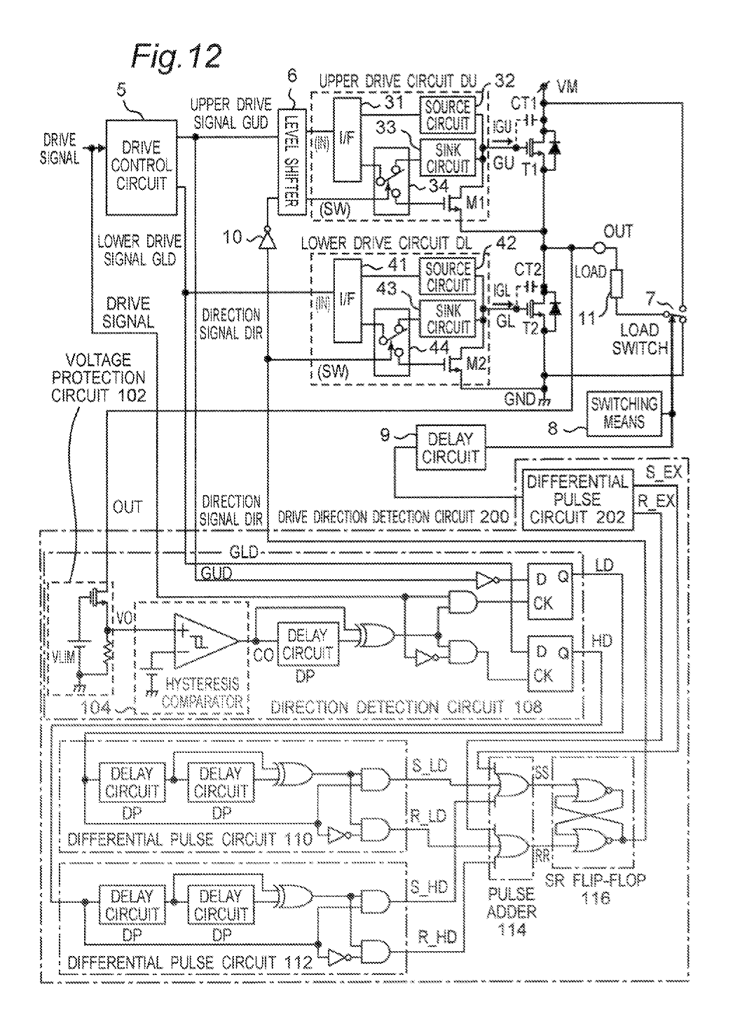

FIG. 12 shows the configuration of a third embodiment of the invention using the drive circuit according to the first embodiment of the invention and a drive direction detection circuit 200 that is a modification of the drive direction detection circuit 100 in the second embodiment of the invention. The operation of this third embodiment is described below.

The third embodiment shown in FIG. 12 is a combination of the first embodiment and the second embodiment.

The difference with the second embodiment is the drive direction detection circuit 200 used in the third embodiment. This drive direction detection circuit 200 additionally has a differential pulse circuit 202 that receives output signals from the switching means 8 that controls the load switch 7 or a delay circuit 9 that is disposed according to the load conditions, and outputs direction signal DIR.

The differential pulse circuit 202 outputs set pulse S_EX and reset pulse R_EX having a particular pulse width at the rising edge and falling edge of the output signal from the switching means 8 or delay circuit 9.

In addition to the set pulse signal group and reset pulse signal group from the differential pulse circuits 110, 112, the pulse signals S-EX and R_EX from the differential pulse circuit 202 are also applied to the pulse adder 114 and SR flip-flop 116 for wave-shaping to generate the direction signal DIR.

As a result, by using the control signal of the switching means 8 in addition to the drive signal and the output voltage of the output terminal OUT of the half-bridge circuit, the signal GUD, and the signal GLD to detect the drive direction, the drive direction detection circuit 200 can output a more reliable direction signal DIR than drive direction detection circuit 100.

### Embodiment 4

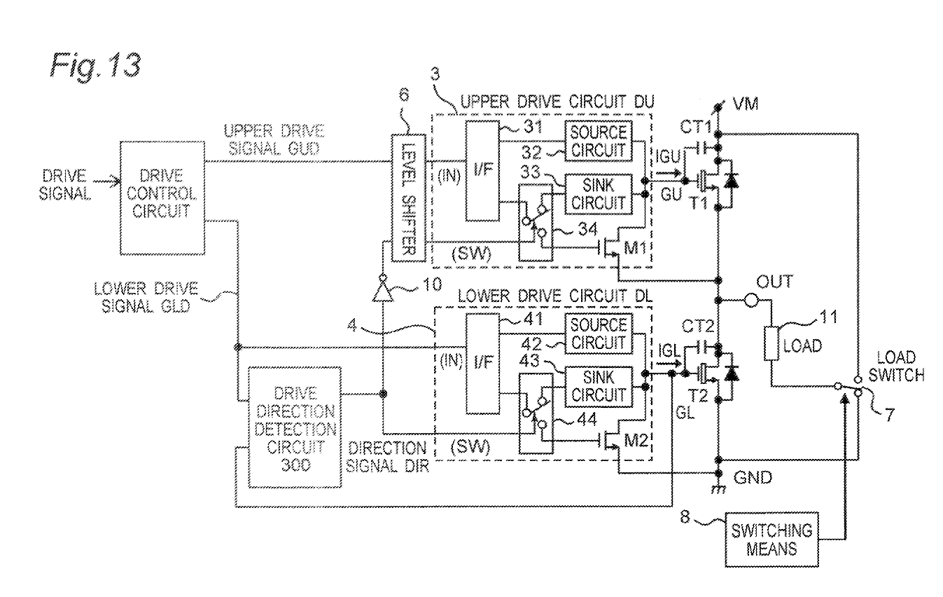

FIG. 13 shows the configuration of a fourth embodiment using the drive circuit according to the first embodiment of the invention and the drive direction detection circuit 300 according to the third embodiment. The operation of this fourth embodiment is described next.

FIG. 13 shows a half-bridge circuit using the drive circuit of the first embodiment and the drive direction detection circuit 300 of the third embodiment.

The configuration of the half-bridge circuit is substantially the same as the half-bridge circuit of the second embodiment shown in FIG. 9, and differs in that the drive direction detection circuit 100 is replaced by the drive direction detection circuit 300 used in the third embodiment of the invention.

Because this half-bridge circuit is substantially identical to the half-bridge circuit described in the second embodiment, only the operation of the drive direction detection circuit 300 is described below.

The drive direction detection circuit 300 detects the direction of the load current of the load connected to the output terminal OUT of the half-bridge circuit from the gate voltage GL and lower drive signal GLD of the transistor T2 of the half-bridge circuit, and outputs direction signal DIR HIGH or LOW according to the directional polarity.

The lower drive circuit DL directly detects the direction signal DIR, and the upper drive circuit DU detects the direction signal DIR through the inverter and level shifter, and the drive circuits DL and DU select the sink circuit or sink transistor by means of the respective selectors. By applying this drive direction detection circuit 300 to the half-bridge circuit, the slew rate of the output voltage of the half-bridge circuit can be desirably set and shoot-through (through state) can be prevented even if the load of the half-bridge circuit is an inductive load with an inductance component.

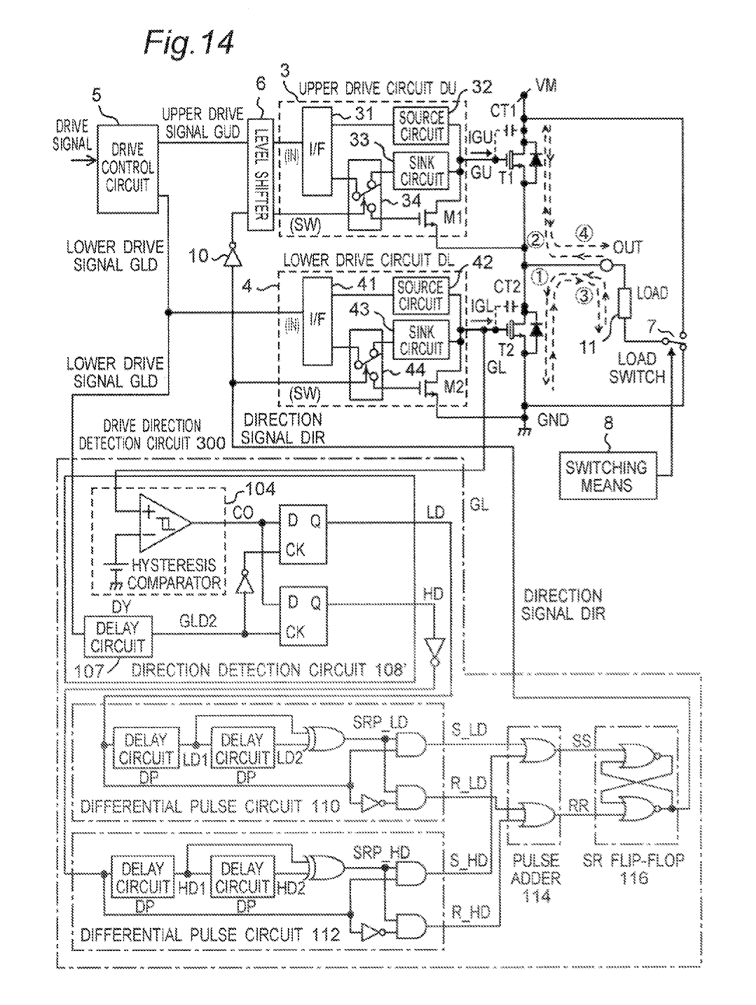

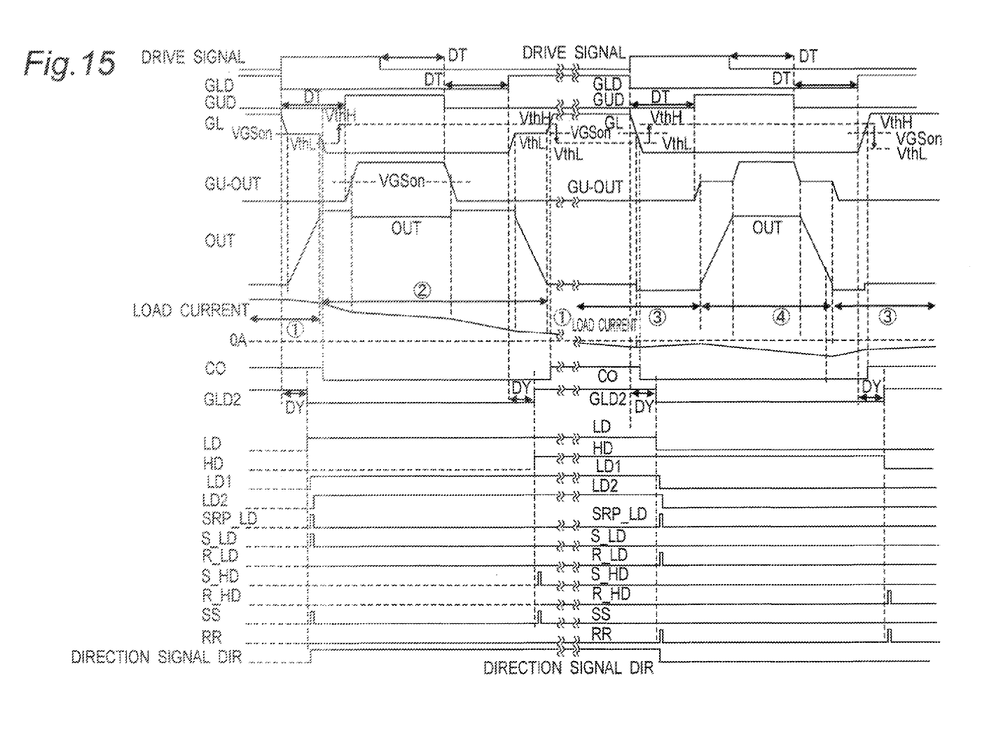

The operation of the drive direction detection circuit 300 in the third embodiment is described next using FIG. 14 and FIG. 15. FIG. 14 is a block diagram showing the configuration of the drive direction detection circuit 300 according to the fourth embodiment of the invention in detail, and FIG. 15 is a timing chart of the signals shown in FIG. 14.

Similarly to the drive direction detection circuit 100 shown in FIG. 10, the drive direction detection circuit 300 according to the third embodiment of the invention includes a direction detection circuit 108′, two differential pulse circuits 110, 112, a pulse adder 114, and SR flip-flop 116. The difference from the drive direction detection circuit 100 is the replacement of the direction detection circuit 108 with direction detection circuit 108′. As a result, because the method whereby the drive direction detection circuit 300 outputs the direction signal DIR is the same as that of the drive direction detection circuit 100, further description thereof is omitted, and only the 108′ is described below.

The direction detection circuit 108′ includes a hysteresis comparator 104, LD output terminal, HD output terminal, and a delay circuit 107 that delays the lower drive signal GLD a specific time.

The LD output terminal of the direction detection circuit 108′ outputs HIGH if the gate voltage GL of the transistor T2 is higher than the threshold voltage VthL of the hysteresis comparator 104 when the falling edge of delay signal GLD2, which is the lower drive signal GLD delayed a certain time, is detected, and outputs LOW when the gate voltage GL of the transistor T2 is less than the threshold voltage VthL.

The HD output terminal of the direction detection circuit 108′ outputs LOW if the gate voltage GL of the transistor T2 is higher than the threshold voltage VthL of the hysteresis comparator 104 when the rising edge of delay signal GLD2, which is the lower drive signal GLD delayed a certain time, is detected, and outputs HIGH when the gate voltage GL of the transistor T2 is less than the threshold voltage VthL.

Whether the output terminal OUT of the half-bridge circuit is SOURCE outputting or SINK inputting the load current can be determined as a result of the direction detection circuit 108′ outputting direction detection signals HD and LD as described above.

This is described in the timing chart in FIG. 15. The left side in FIG. 15 shows when the load current is SINK input to the OUT terminal, and the right side in FIG. 15 shows when the load current is SOURCE output from the OUT terminal. The drive signal, upper drive signal GUD, lower drive signal GLD, the gate voltage GU-OUT of transistor T1, the gate voltage GL of transistor T2, and the output voltage OUT (VO) are shown separately in FIG. 15 for the load currents (1), (2), (3), and (4) in FIG. 14.

Based on the timing chart of these signal waveforms and the foregoing operating description of the direction detection circuit 108′, it can be determined that if the direction signals LD and HD change from LOW to HIGH, the load current is SINK input to the output terminal OUT of the half-bridge circuit, and if the direction signals LD and HD change from HIGH to LOW, the load current is SOURCE output [input? sic?] to the output terminal OUT of the half-bridge circuit.

Note that direction signal LD is the direction detection signal when the half-bridge circuit output OUT rises, and direction signal HD is the direction detection signal when the half-bridge circuit output OUT falls. This means that the direction detection circuit 108 has two direction detection circuits. These two direction detection circuits detect the direction of the load current at different times on the time base.

The purpose and operation of the differential pulse circuit, pulse adder, and SR flip-flop are described in the foregoing second embodiment, and further description thereof is thus omitted.

As a result, when the load of the half-bridge circuit is an inductive load with an inductance component, a half-bridge circuit using the drive circuit according to the first embodiment of the invention and the drive direction detection circuit 300 can appropriately detect the direction of the load current, desirably set the slew rate of the output voltage of the half-bridge circuit, and prevent shoot-through (through state) whenever the direction of the load current of this inductive load changes.

### Embodiment 5

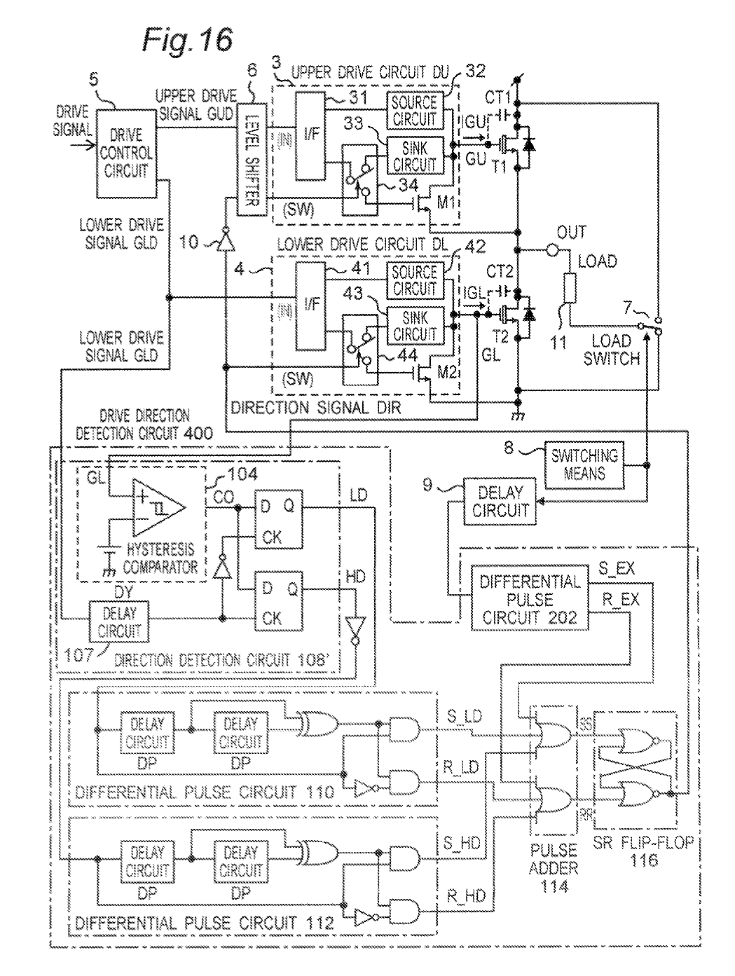

FIG. 16 shows the configuration of a fifth embodiment of the invention using the drive circuit according to the first embodiment of the invention and a drive direction detection circuit 400 that is a modification of the drive direction detection circuit 300 in the third embodiment of the invention. The operation of this fifth embodiment is described below.

The fifth embodiment shown in FIG. 16 is a combination of the first embodiment and the fourth embodiment.

The difference with the fourth embodiment is the drive direction detection circuit 400 used in the fifth embodiment. This drive direction detection circuit 400 additionally has a differential pulse circuit 202 that receives output signals from the switching means 8 that controls the load switch 7 or a delay circuit that is disposed according to the load conditions, and outputs direction signal DIR.

The differential pulse circuit 202 outputs set pulse S_EX and reset pulse R_EX having a particular pulse width at the rising edge and falling edge of the output signal from the switching means 8 or delay circuit 9.

In addition to the set pulse signal group and reset pulse signal group from the differential pulse circuits 110, 112, the pulse signals S-EX and R_EX from the differential pulse circuit 202 are also applied to the pulse adder 114 and SR flip-flop 116 for wave-shaping to generate the direction signal DIR.

As a result, by using the control signal of the switching means 8 in addition to the gate voltage GL of the transistor T2 and the lower drive signal GLD of the half-bridge circuit to detect the drive direction, the drive direction detection circuit 400 can output a more reliable direction signal DIR than drive direction detection circuit 300.

### Embodiment 6

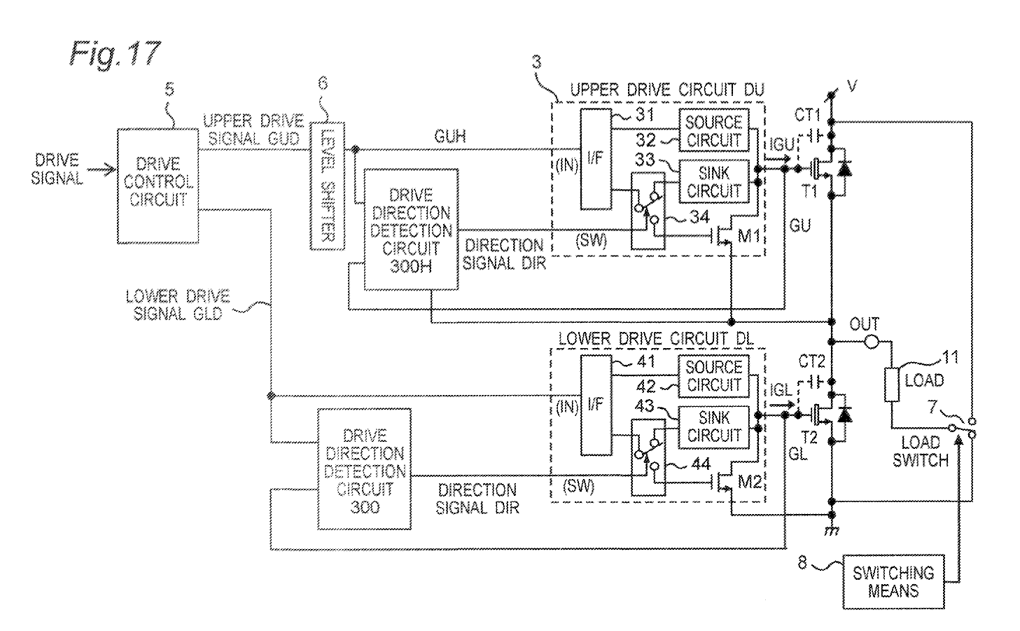

FIG. 17 shows the configuration of a sixth embodiment of the invention using the drive circuit according to the first embodiment of the invention, the drive direction detection circuit 300 of the third embodiment, and a drive direction detection circuit 300H that is a slight modification of the drive direction detection circuit 300 in the third embodiment of the invention. The operation of this sixth embodiment is described below.

FIG. 17 shows an half-bridge circuit using the drive circuit according to the first embodiment of the invention, the drive direction detection circuit 300 of the third embodiment, and this drive direction detection circuit 300H.

The half-bridge circuit includes: switching devices T1 and T2, which in this embodiment of the invention are two power MOSFET transistors to which a capacitive current flows to the control terminal thereof during the off period; two upper drive circuits DU and DL that drive the transistors T1 and T2; a drive control circuit 5 that signal processes the drive signal that drives the half-bridge circuit, and generates an upper drive signal GUD that is input to the upper drive circuit DU that drives the upper transistor T1, and a lower drive signal GLD that is input to the lower drive circuit DL that drives the lower transistor T2; a level shifter 6 that relays the GUD signal to the upper drive circuit DU; a load switch 7 that switches the connection of the other end of the load 11 that is connected to the output terminal OUT of the half-bridge output circuit to the power supply VM or to GND; a switching means 8 that controls switching the load switch 7; the drive direction detection circuit 300; and the drive direction detection circuit 300H.

The half-bridge circuit according to the sixth embodiment of the invention is substantially the same as described in the fourth embodiment, and differs from the fourth embodiment in the addition of the drive direction detection circuit 300H.

The drive direction detection circuit 300H is a drive direction detection circuit specifically for the upper drive circuit DU of the half-bridge circuit, and the direction signal DIR_H output from the drive direction detection circuit 300H can directly control the selector 34 of the upper drive circuit DU instead of passing through the level shifter 6.

This configuration reduces the load on the circuit design of the level shifter 6.

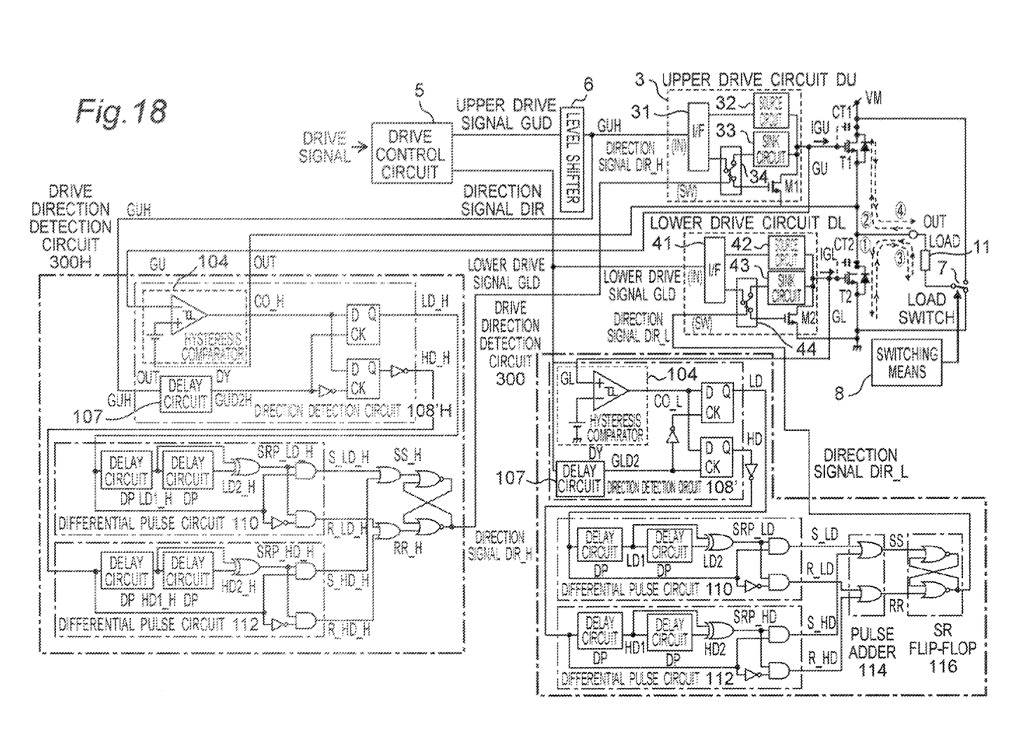

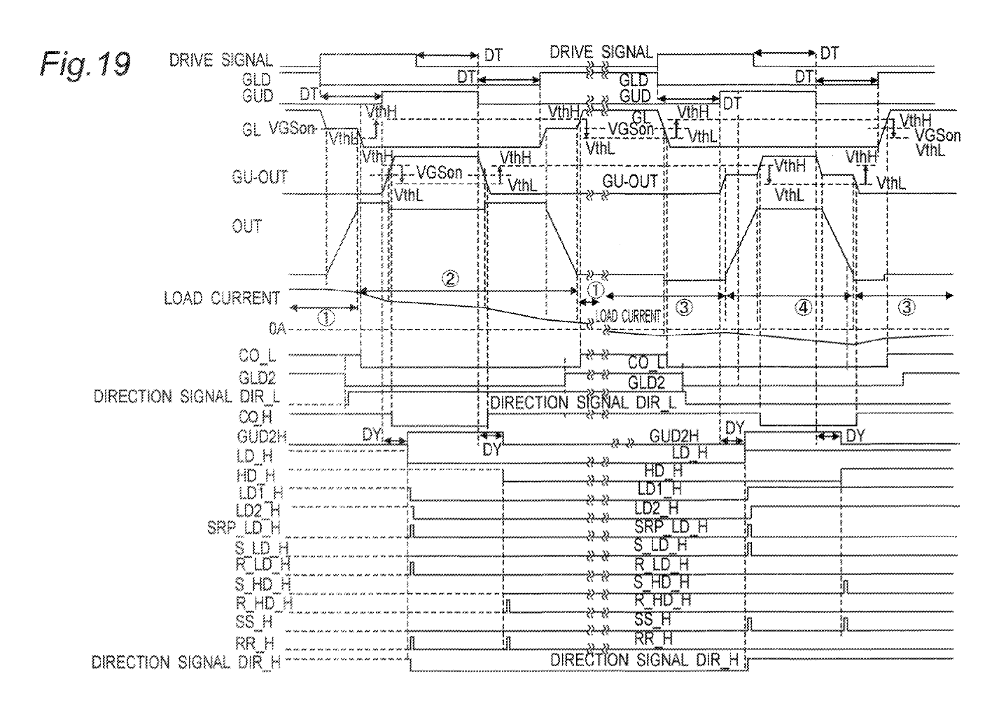

The operation of the drive direction detection circuit 300H is described next using FIG. 18 and FIG. 19. FIG. 18 is a block diagram showing in detail the configuration of the drive direction detection circuit 300H and drive direction detection circuit 300 of the sixth embodiment shown in FIG. 17, and FIG. 19 is a timing chart of the signal shown in FIG. 18.

The drive direction detection circuit 300 of the third embodiment was described in the fourth embodiment, and further description thereof is thus omitted.

The drive direction detection circuit 300H differs from the drive direction detection circuit 300 in the following two ways.

(1) As shown in FIG. 17 and FIG. 18, the potential of the low power supply side of the drive direction detection circuit 300H is not the ground potential GND of the half-bridge circuit, but is the output voltage OUT of the half-bridge circuit.

(2) As shown in FIG. 18, the signal polarities of the direction detection circuit differ from the signals of the direction detection circuit in drive direction detection circuit 300.

As a result of (1) above, the direction signal DIR from the drive direction detection circuit 300H can be passed directly to the upper drive circuit DU without passing through the level shifter 6. As a result, the polarity of direction detection circuit signals must be changed as described in (2) above.

As shown in FIG. 18, the circuit design of the direction detection circuit 108′H of the drive direction detection circuit 300H is substantially the same as the direction detection circuit 108 of the drive direction detection circuit 300, and the signal polarities are slightly different.

As a result, the direction detection operation of the direction detection circuit 108′H is the same as the direction detection circuit 108′.

As shown in FIG. 18 and FIG. 19, the LD_H output terminal of the direction detection circuit 108′H outputs LOW if the gate voltage GU-OUT of the upper transistor T1 is higher than the threshold voltage VthH of the hysteresis comparator 104 in the direction detection circuit 108′H when the rising edge of delay signal GUD2H, which is the upper drive signal GUD delayed a certain time after passing through the level shifter 6, is detected, and outputs HIGH when the gate voltage GU-OUT of the upper transistor T1 is less than the threshold voltage VthL.

At a time when the falling edge of delay signal GUD2H, which is the upper drive signal GUD delayed a certain time after passing through the level shifter 6, is detected, the HD_H output terminal of the direction detection circuit 108′ outputs LOW if the gate voltage GU-OUT of the upper transistor T1 is less than the threshold voltage VthL of the hysteresis comparator, and outputs HIGH when the gate voltage GU-OUT of the upper transistor T1 is greater than the threshold voltage VthL.

Whether the output terminal OUT of the half-bridge circuit is SOURCE outputting or SINK inputting the load current can be determined by the direction detection circuit 108′H outputting the direction detection signals HD_H and LD_H as described above.

This is described in the timing chart in FIG. 19. The left side in FIG. 19 shows when the load current is SINK input to the OUT terminal, and the right side in FIG. 19 shows when the load current is SOURCE output from the OUT terminal. The drive signal, upper drive signal GUD, lower drive signal GLD, the gate voltage GU-OUT of transistor T1, the gate voltage GL of transistor T2, and the output voltage OUT (VO) are shown separately in FIG. 19 for the load currents (1), (2), (3), and (4) in FIG. 18.

Based on the timing chart of these signal waveforms and the foregoing operating description of the direction detection circuit 108′H, it can be determined that if the direction signals LD_H and HD_H change from HIGH to LOW, the load current is SINK input to the output terminal OUT of the half-bridge circuit, and if the direction signals LD_H and HD_H change from LOW to HIGH, the load current is SOURCE output to the output terminal OUT of the half-bridge circuit.

Note that direction signal LD_H is the direction detection signal when the output OUT of the half-bridge circuit rises, and the direction signal HD_H is the direction detection signal when the output OUT of the half-bridge circuit falls.

This direction detection circuit 108′H can detect the direction of the load current in two transition states, that is, when the output OUT of the half-bridge circuit rises and when it falls.

### Embodiment 7

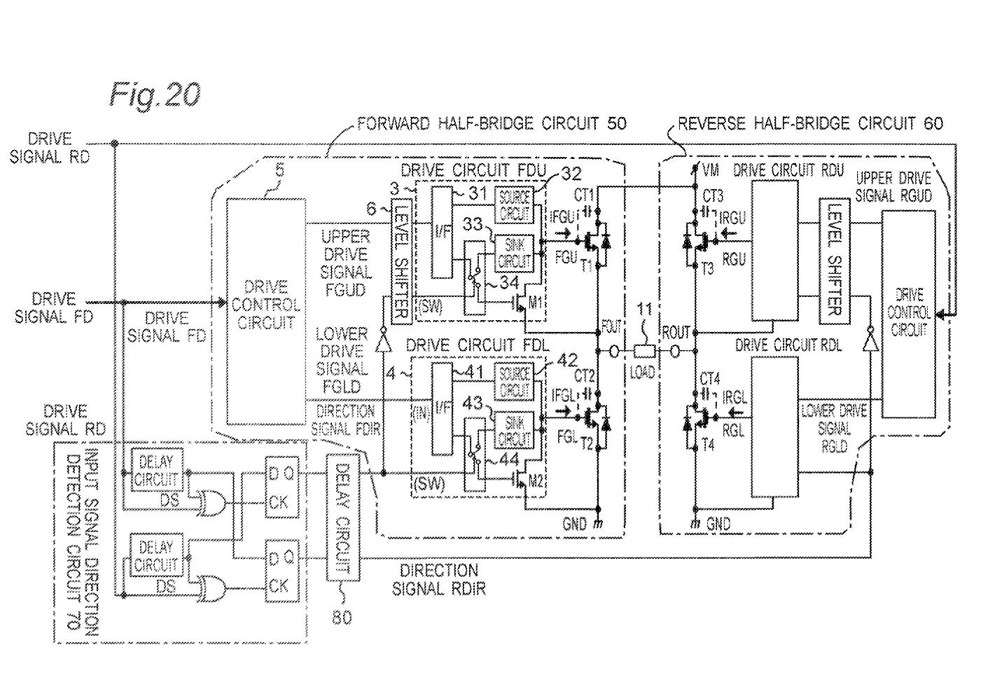

The seventh embodiment of the invention shown in FIG. 20 renders an H bridge circuit using the drive circuit according to the first embodiment of the invention. The operation of this seventh embodiment is described next.

FIG. 20 shows an H bridge circuit using the drive circuit according to the first embodiment of the invention.

This embodiment of the invention has two H bridge circuits that function as a circuit pair to drive the load 11. These two circuits are referred to as a forward circuit 50 and a reverse circuit 60.

The load 11 driven by the H bridge circuit is inserted between the output terminal FOUT of the forward circuit 50, and the output terminal ROUT of the reverse circuit 60.

The forward circuit 50 and reverse circuit 60 are identical, and are rendered by half-bridge circuits. The configuration of the half-bridge circuits is described below, but because the forward and reverse side circuits are identical, the forward half-bridge circuit is described for brevity.

The forward half-bridge circuit 50 includes: switching devices T1 and T2, which in this embodiment of the invention are two power MOSFET transistors to which a capacitive current flows to the control terminal thereof during the off period; two upper drive circuits FDU and FDL that drive the transistors T1 and T2; a drive control circuit 5 that signal processes the drive signal that drives the half-bridge circuit, and generates an upper drive signal FGUD that is input to the upper drive circuit FDU that drives the upper transistor T1, and a lower drive signal FGLD that is input to the lower drive circuit FDL that drives the lower transistor T2; a level shifter 6 that relays the FGUD signal to the upper drive circuit FDU; an inverter 10 that inverts the polarity of the input signal to the selector of the upper drive circuit FDU and the input signal to the selector of the lower drive circuit FDL.

The H bridge circuit is rendered by the two half-bridge circuits 50 and 60 described above, and an input signal direction detection circuit 70 for determining the drive direction of the load 11 inserted between the output terminals FOUT and ROUT.

The input signal direction detection circuit 70 detects the two input signals to the H bridge circuit, that is, the drive signal FD of the forward half-bridge circuit 50 and the drive signal RD of the reverse half-bridge circuit 60, and determines if the H bridge circuit load is driven by the SOURCE output of the forward half-bridge circuit 50 or the SINK input of the reverse half-bridge circuit 60, or the reverse, and outputs direction signals FDIR and RDIR of the appropriate polarity to the forward half-bridge circuit 50 and reverse half-bridge circuit 60.

As described above, a delay circuit 80 with an appropriate delay time may be disposed between the output terminal of the input signal direction detection circuit 70 and the input terminal of the inverter 10 of each half-bridge circuit and the input terminal of the selector in the lower drive circuit. This is to compensate for the delay in the change in the direction in which the load current flows to the change in the direction of load drive when the load driving direction changes when the load 11 is an inductive load with an inductive component, and the delay time of the delay circuit 80 can be set appropriately according to the inductance component and the resistance component of the load.

However, because whether the direction of the load current changed from the SOURCE output to the SINK input at the correct timing cannot be known with only the delay circuit 80, a direction detection circuit that detects the change in the direction of the load current may be used to detect the direction of the load current and based thereon send the direction signal DIR to the upper and lower drive circuits DU and DL. This is described in another embodiment of the invention below.

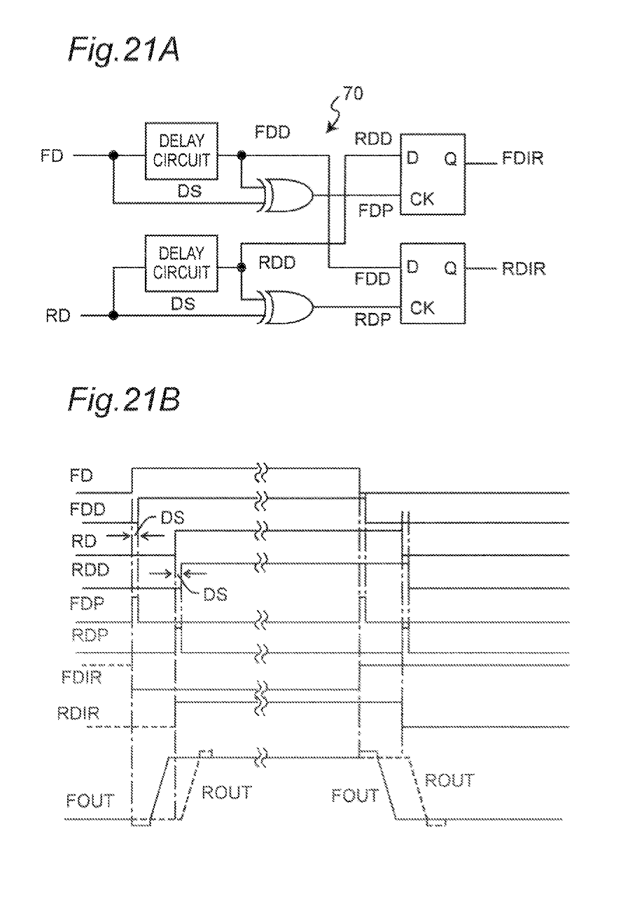

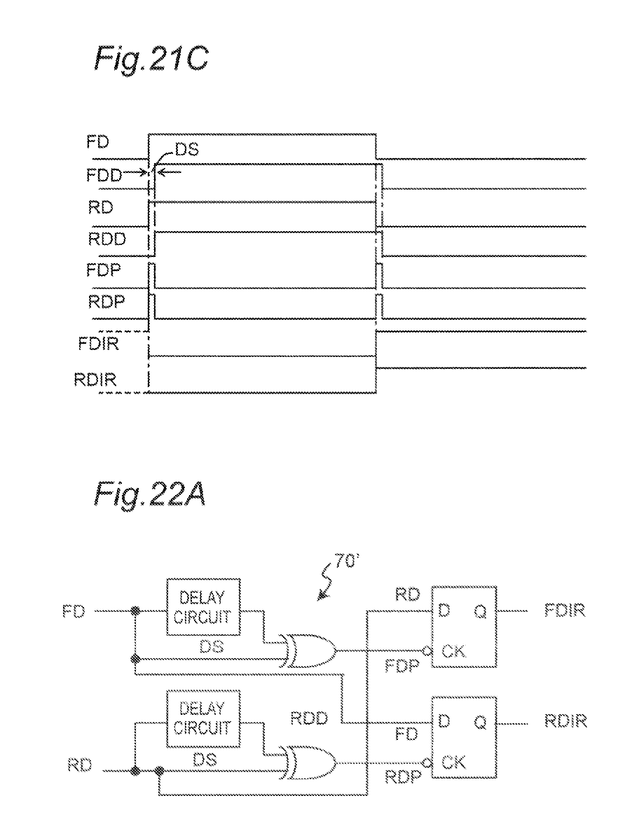

Circuit diagrams and a timing chart describing the operation of the input signal direction detection circuit 70 shown in FIG. 20 are shown in FIG. 21A, FIG. 21B, and FIG. 21C. The timing chart in FIG. 21B shows an example in which the time difference between the drive signal FD of the forward half-bridge circuit 50 and the drive signal RD of the reverse half-bridge circuit 60 is greater than the delay time DS of the delay circuit of the input signal direction detection circuit 70 (FIG. 21A). This delay time DS is normally set to a shorter time than the minimum setting of the time difference between the drive signals FD and RD whereby the H bridge circuit drives the load.

The function of the input signal direction detection circuit 70 is described next using the timing charts in FIG. 21B and FIG. 21C. More specifically, FIG. 21B shows when the time difference between FD and RD is greater than DS, and FIG. 21C shows when there is no time difference between FD and RD.

The output voltage of the output terminal FOUT of the H bridge circuit rises after a certain delay time as shown in FIG. 11, FIG. 15, and FIG. 19 from the rising edge of the drive signal FD of the forward half-bridge circuit 50. This delay time changes according to the direction of the load current, and variation in the load current and the characteristics of transistors T1 and T2. Similarly to the output voltage of the output terminal FOUT, the output voltage of the output terminal ROUT of the H bridge circuit also rises after a certain delay time from the rising edge of the drive signal RD of the reverse half-bridge circuit 60.

As shown in FIG. 21B, when drive signal FD rises before drive signal RD, the FOUT voltage rises before the ROUT voltage, and the load current therefore flows from the FOUT terminal to the ROUT terminal through the load when the load is a common load such as not an inductive load.

At this time the input signal direction detection circuit 70 outputs direction signal FDIR LOW to the forward half-bridge circuit 50, and outputs direction signal RDIR HIGH to the reverse half-bridge circuit 60. As a result, the selector 34 of the upper drive circuit FDU of the forward half-bridge circuit 50 selects sink circuit 33 to operate, and the selector 44 of the lower drive circuit FDL selects the sink transistor M2 ‘to operate. Likewise, the selector of the upper drive circuit RDU in the reverse half-bridge circuit 60 selects the sink transistor M1 to operate, and the selector of the lower drive circuit RDL selects the sink circuit to operate.

The circuit operations of the upper drive circuit FDU and the lower drive circuit FDL of the forward half-bridge circuit 50, and the circuit operations of the upper drive circuit RDU and lower drive circuit RDL of the reverse half-bridge circuit 60, are operations suitable to the direction of the load current. Therefore, by outputting appropriate direction signals FDIR and RDIR, the input signal direction detection circuit 70 can appropriately set the slew rate of the output voltage of the output terminal FOUT and the slew rate of the output voltage of the output terminal ROUT of the H bridge circuit and minimize electromagnetic interference, while also preventing shoot-through (through state) between transistors T1 and T2 and between transistors T3 and T4.

Similarly to the rising edge described above, the output voltage of the output terminal FOUT of the H bridge circuit falls after a certain delay time from the falling edge of the forward half-bridge circuit 50 drive signal FD. This delay time changes according to the direction of the load current, and variation in the load current and the characteristics of transistors T1 and T2. Similarly to the output voltage of the output terminal FOUT, the output voltage of the output terminal ROUT of the H bridge circuit also falls after a certain delay time from the falling edge of the drive signal RD of the reverse half-bridge circuit 60.

As shown in FIG. 21B, when drive signal FD falls before drive signal RD, the FOUT voltage falls before the ROUT voltage, and the load current therefore flows from the ROUT terminal to the FOUT terminal through the load when the load is a common load such as not an inductive load.

At this time the input signal direction detection circuit 70 outputs direction signal FDIR HIGH to the forward half-bridge circuit 50, and outputs direction signal RDIR LOW to the reverse half-bridge circuit 60. As a result, the selector 34 of the upper drive circuit FDU of the forward half-bridge circuit 50 selects sink transistor M1 to operate, and the selector 44 of the lower drive circuit FDL selects the sink circuit to operate. Likewise, the selector of the upper drive circuit RDU in the reverse half-bridge circuit 60 selects the sink circuit to operate, and the selector of the lower drive circuit RDL selects the sink transistor M2 to operate.

The circuit operations of the upper drive circuit FDU and the lower drive circuit FDL of the forward half-bridge circuit 50, and the circuit operations of the upper drive circuit RDU and lower drive circuit RDL of the reverse half-bridge circuit 60, are operations suitable to the direction of the load current. Therefore, by outputting appropriate direction signals FDIR and RDIR, the input signal direction detection circuit 70 can appropriately set the slew rate of the output voltage of the output terminal FOUT and the slew rate of the output voltage of the output terminal ROUT of the H bridge circuit and minimize electromagnetic interference, while also preventing shoot-through (through state) between transistors T1 and T2 and between transistors T3 and T4.

The timing chart in FIG. 21C describes operation when there is no time difference between the drive signal FD of the forward half-bridge circuit 50 and the drive signal RD of the reverse half-bridge circuit 60. In this case, direction signals FDIR and RDIR both go LOW at the rising edge of the forward half-bridge circuit 50 drive signal FD and the reverse half-bridge circuit 60 drive signal RD. As a result, the selectors of the upper drive circuits in the forward half-bridge circuit 50 and reverse half-bridge circuit 60 of the H bridge circuit select the sink circuits, and the selectors of the lower drive circuits select the sink transistors M2.

In addition, direction signals FDIR and RDIR both go HIGH at the falling edge of the forward half-bridge circuit 50 drive signal FD and the reverse half-bridge circuit 60 drive signal RD. As a result, the selectors of the upper drive circuits in the forward half-bridge circuit 50 and reverse half-bridge circuit 60 of the H bridge circuit select the sink transistors M1, and the selectors of the lower drive circuits select the sink circuits.

Even when there is no time difference between the drive signal FD of the forward half-bridge circuit 50 and the drive signal RD of the reverse half-bridge circuit 60, the input signal direction detection circuit 70 can thus appropriately set the slew rate of the output voltage of the output terminal FOUT and the slew rate of the output voltage of the output terminal ROUT of the H bridge circuit and minimize electromagnetic interference, while also preventing shoot-through (through state) between transistors T1 and T2 and between transistors T3 and T4.

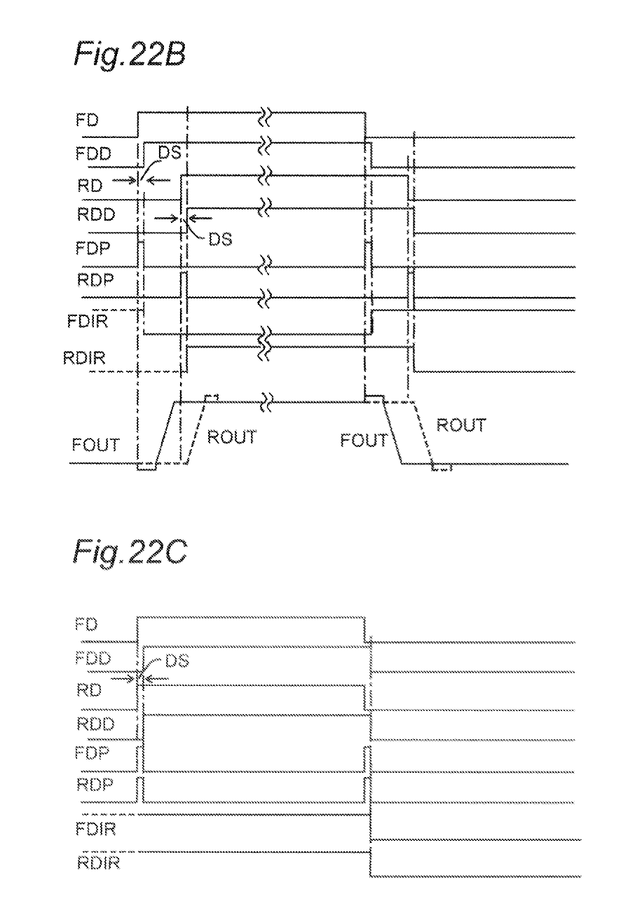

Note that the input signal direction detection circuit 70 of the H bridge circuit shown in FIG. 20 can be replaced by the input signal direction detection circuit 70’ configured as shown in FIG. 22A and described in FIG. 22B and FIG. 22C. More specifically, FIG. 22B describes operation when the time difference between FD and RD is greater than DS, and FIG. 22C shows when there is no time difference between FD and RD.

The effect and operation using the input signal direction detection circuit 70′ when the time difference between the drive signal FD of the forward half-bridge circuit 50 and the drive signal RD of the reverse half-bridge circuit 60 is greater than the delay time DS are the same as when the input signal direction detection circuit 70 is used as shown in FIG. 21A, FIG. 21B, and FIG. 21C. However, when there is no time difference between drive signal FD and drive signal RD, the polarities of the direction signals FDIR and RDIR differ from those shown in FIG. 21A, FIG. 21B, and FIG. 21C.

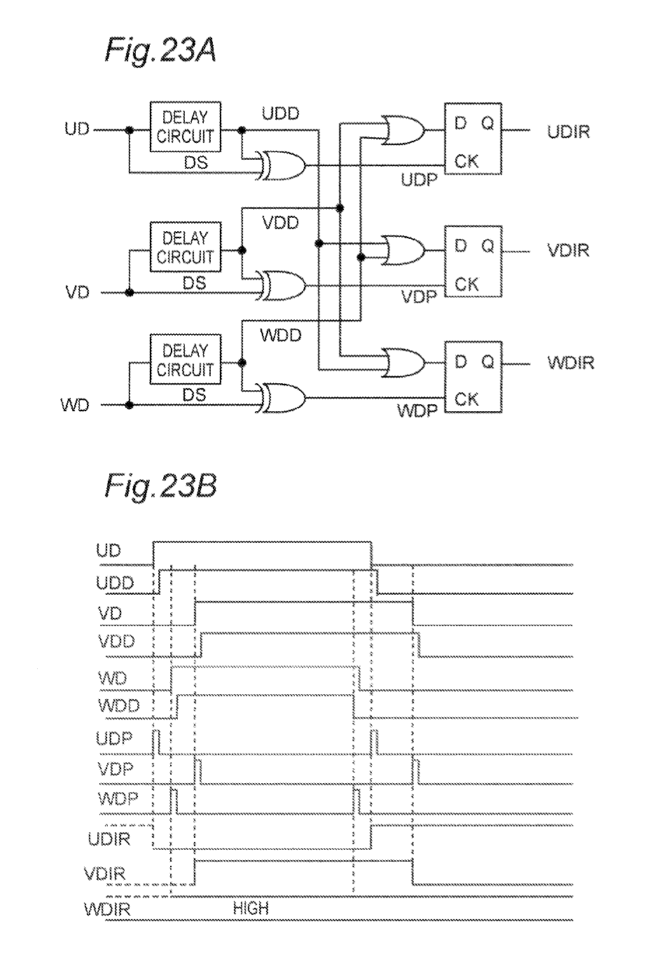

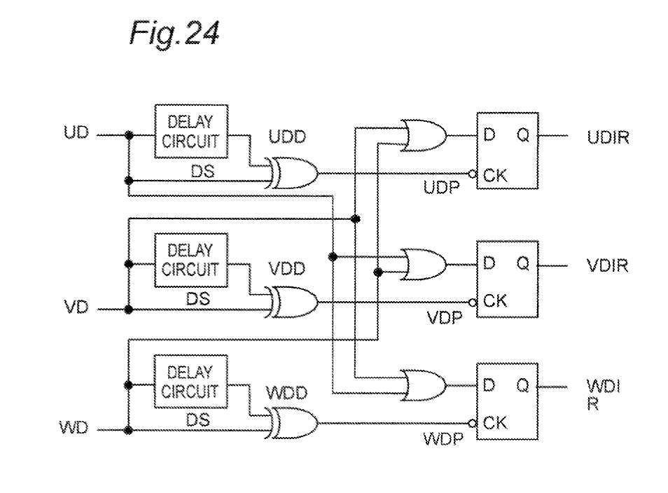

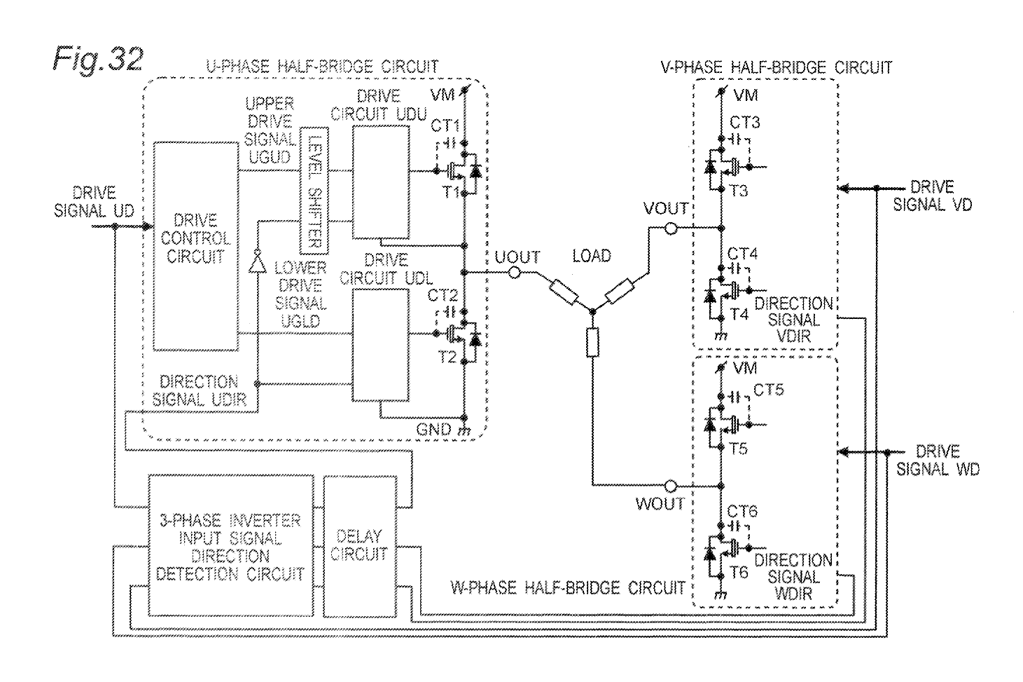

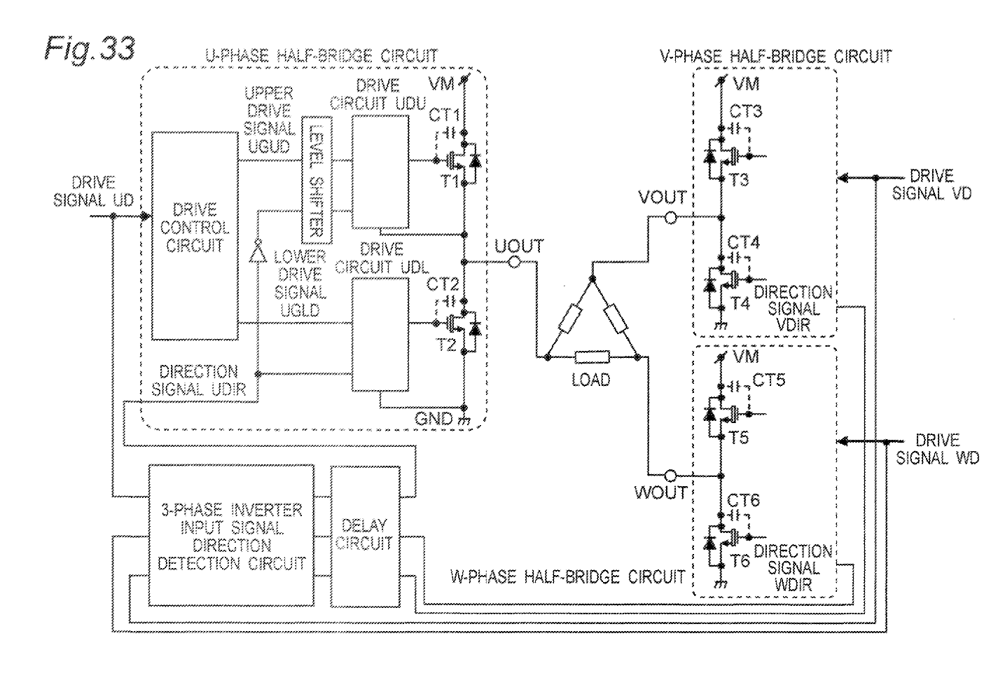

The drive circuit of the first embodiment is applied to an H bridge circuit in this seventh embodiment of the invention, but the drive circuit may be applied to a 3-phase inverter circuit or multi-phase inverter circuit as shown in FIG. 32 and FIG. 33. Application to such inverters can be easily conceptualized and understood from the configuration of the H bridge circuit shown in FIG. 20, and further description thereof is thus omitted, and an example of the configuration of the input signal direction detection circuit used with a 3-phase inverter is limited to FIG. 23A, FIG. 23B, and FIG. 24. FIG. 23A and FIG. 23B show the configuration of the input signal direction detection circuit of a 3-phase inverter and a timing chart for the same. The timing chart shows how the direction signals UDIR, VDIR, and WDIR of each phase are output from the U-phase drive signal UD, V-phase drive signal VD, and W-phase drive signal WD of the 3-phase inverter.

From the relationship between the drive signals UD, VD, WD in the timing chart, the direction signals UDIR, VDIR, and WDIR of each phase set the drive circuits of the half-bridge circuit for each phase so that the U-phase SOURCE outputs the load current, and the V-phase and W-phase SINK input the load current, at the rising edge of each drive signal.

At the falling edge of each drive signal, the direction signals UDIR, VDIR, and WDIR of each phase set the drive circuits of the half-bridge circuit for each phase so that the V-phase SOURCE outputs the load current, and the U-phase and W-phase SINK input the load current.

FIG. 24 shows the configuration of the input signal direction detection circuit for another 3-phase inverter. This shows an application of the H bridge circuit in FIG. 22A to 3-phase.

The directional settings of these direction signals are correct when the load is a resistance load without an inductance component. However, when the load is an inductive load with an inductance component or a motor load that produces induction voltage, the flow of the load current of each phase does not match the output voltage of each phase, and the direction settings of these direction signals are not the correct settings for the load current of each phase.

An embodiment of an H bridge circuit using a drive direction detection circuit that appropriately detects the direction of the load current of each phase, and sends direction signals to the selector of the drive circuit of the half-bridge circuit of each phase, is described below. The concept of this embodiment of an H bridge circuit can also be directly applied to a 3-phase inverter or a multi-phase inverter.

### Embodiment 8

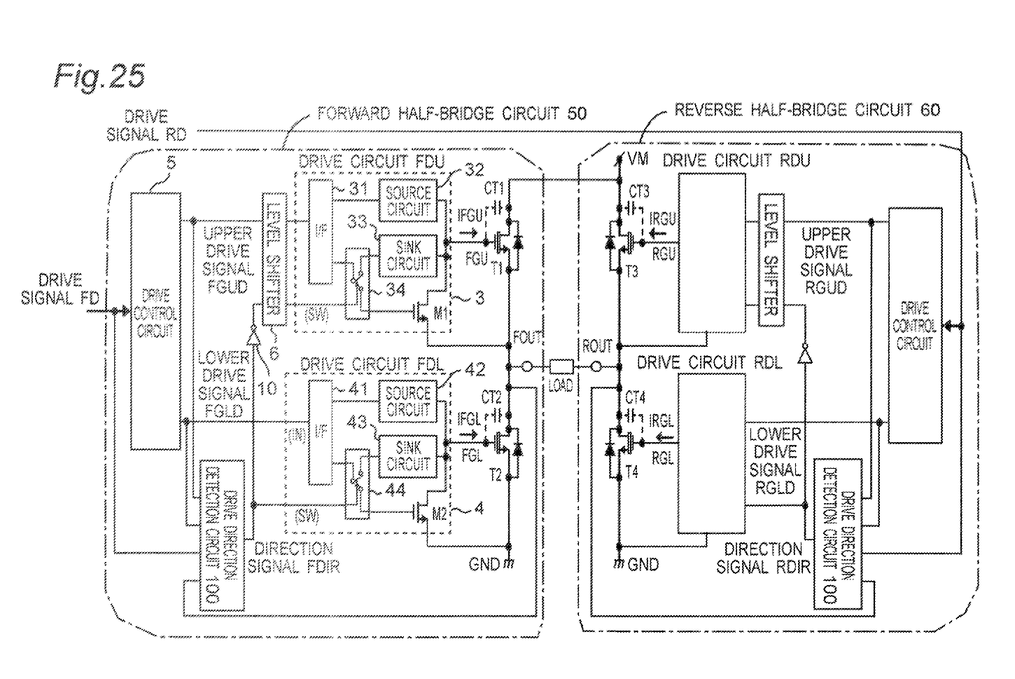

The eight embodiment shown in FIG. 25 renders an H bridge circuit using two sets of half-bridge circuits each using the drive circuit according to the first embodiment of the invention and the drive direction detection circuit 100 according to the second embodiment of the invention.

The operating principle of this H bridge circuit is the same as the half-bridge circuit using the drive circuit according to the second embodiment of the invention and the drive direction detection circuit 100 according to the second embodiment, and further description of the operation of this embodiment is thus omitted.

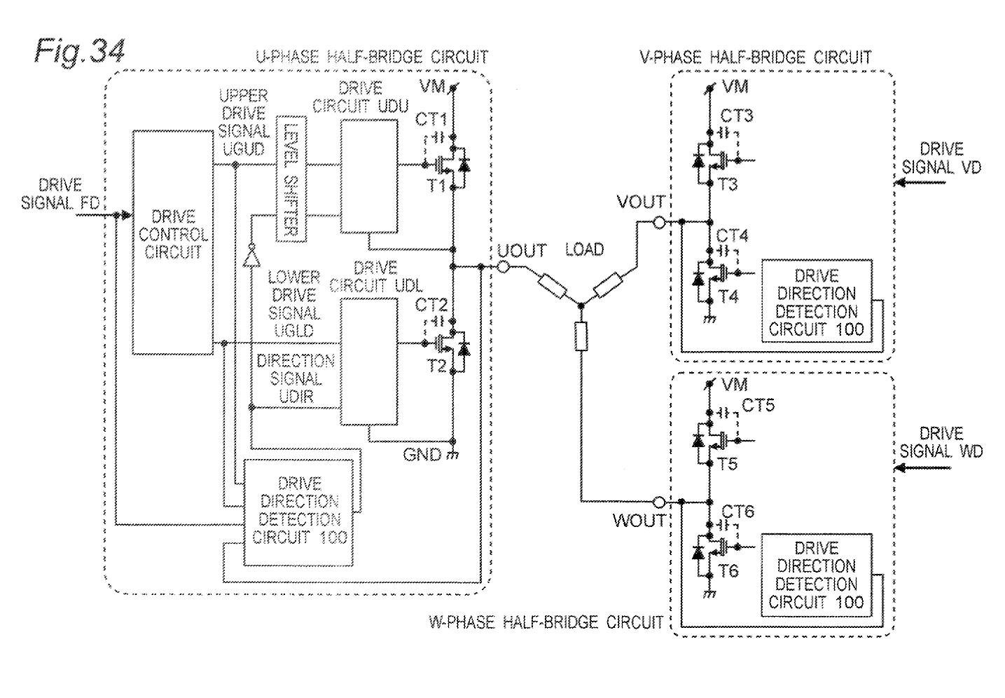

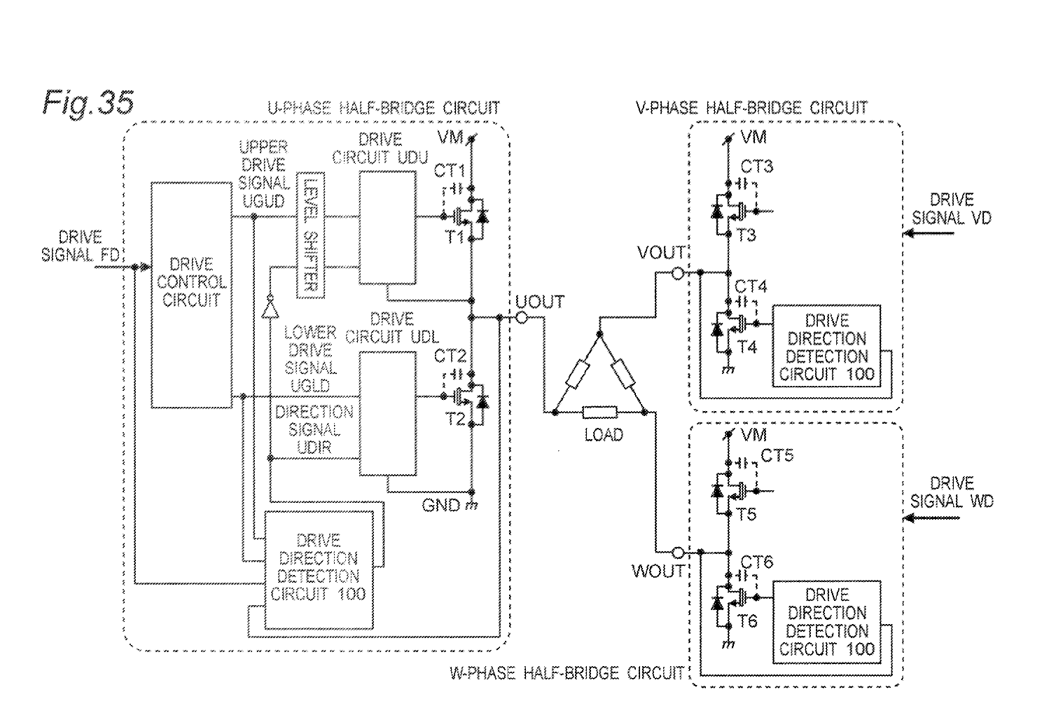

This eighth embodiment renders an H bridge circuit using the drive circuit of the first embodiment and the drive direction detection circuit 100 of the second embodiment, but the eighth embodiment is not limited to an H bridge circuit and can be applied to a 3-phase inverter or multi-phase inverter as shown in FIG. 34 and FIG. 35.

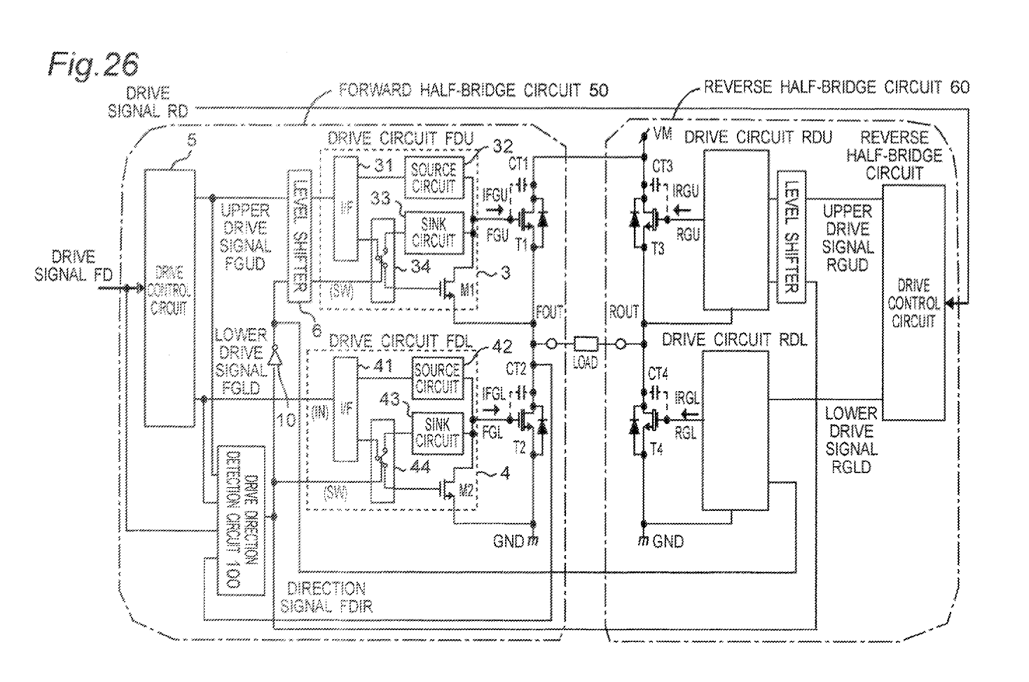

FIG. 26 shows another example of an H bridge circuit using the drive circuit of the first embodiment and the drive direction detection circuit 100 of the second embodiment. This configuration omits the drive direction detection circuit 100 in the reverse half-bridge circuit from the H bridge circuit configuration shown in FIG. 25. In an H bridge circuit the half-bridge circuits only have two phases, and if the load drive current direction of the half-bridge circuit in the forward half-bridge circuit for one phase can be determined, the load drive current direction of the half-bridge circuit for the half-bridge circuit on the reverse side is also known, and the drive direction detection circuit 100 can therefore be omitted from the reverse side circuit. A drive direction detection circuit 100 is needed in the half-bridge circuit of each phase in a 3-phase inverter or multi-phase inverter.

### Embodiment 9

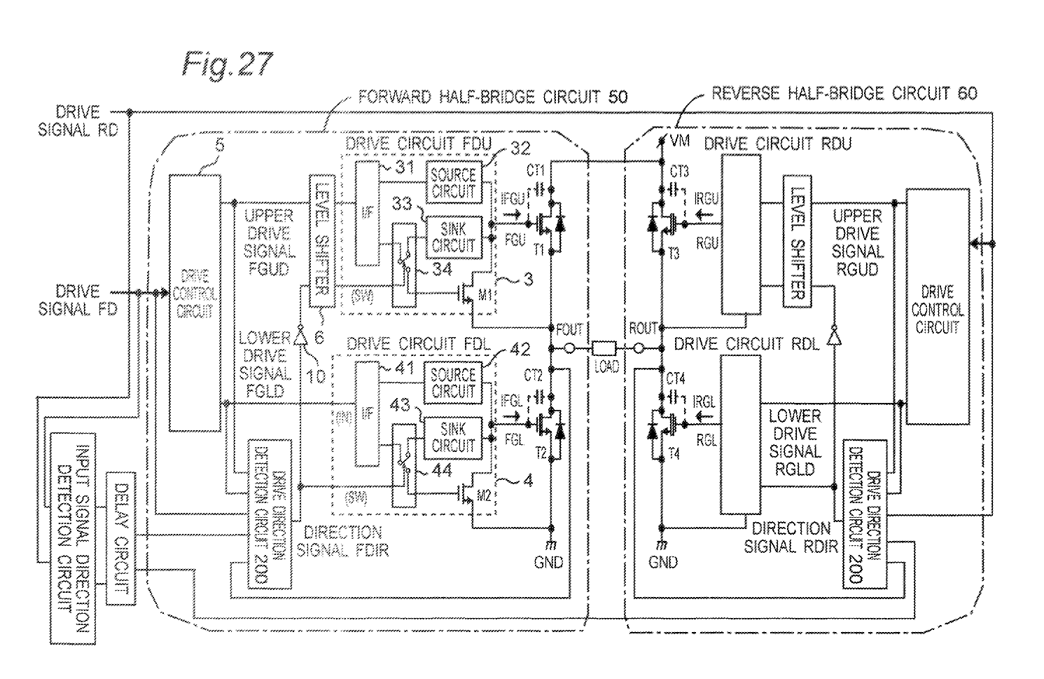

The ninth embodiment shown in FIG. 27 renders an H bridge circuit using two half-bridge circuits each using the drive circuit of the first embodiment and the drive direction detection circuit 200 described in the third embodiment, and the input signal direction detection circuit described in the seventh embodiment.

The operating principle of this H bridge circuit duplicates the description of the half-bridge circuit according to the third embodiment of the invention and the description of the H bridge circuit according to the seventh embodiment of the invention, and further description thereof is thus omitted.

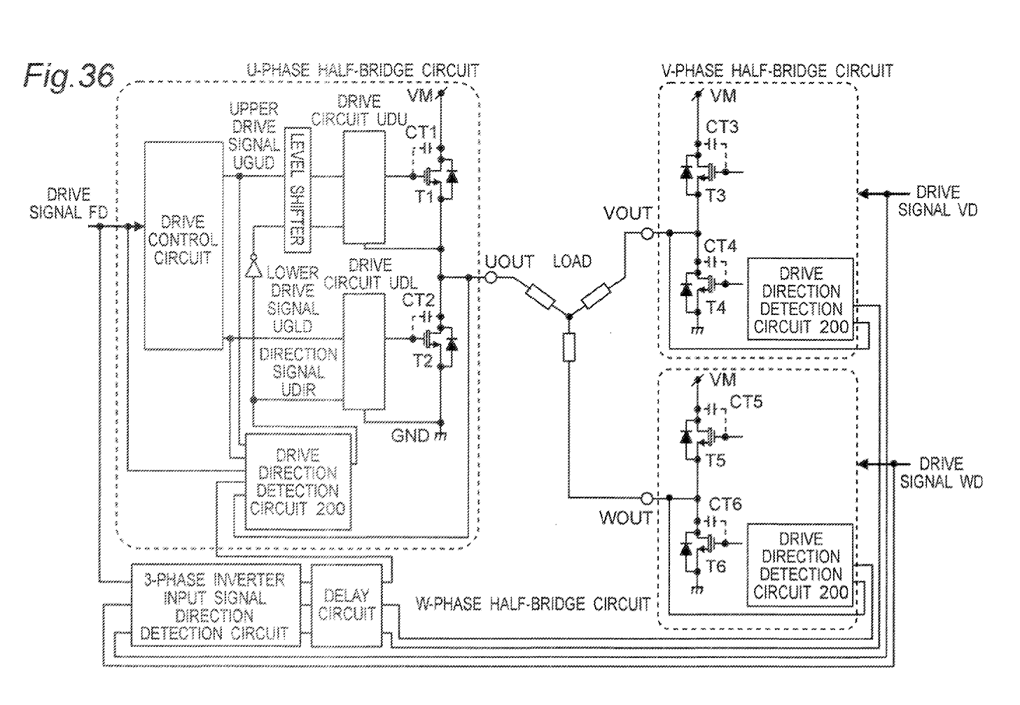

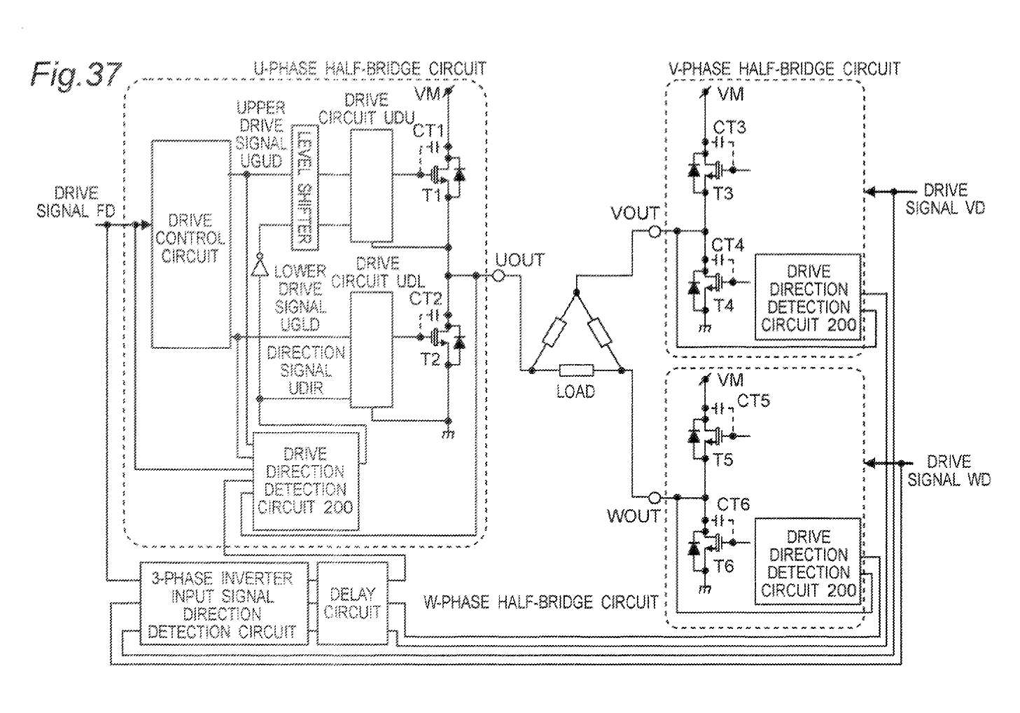

This ninth embodiment describes an H bridge circuit using the drive circuit of the first embodiment and the drive direction detection circuit 200 described in the third embodiment, but the ninth embodiment is not limited to an H bridge circuit and can be applied to a 3-phase inverter or multi-phase inverter as shown in FIG. 36 and FIG. 37.

### Embodiment 10

The tenth embodiment shown in FIG. 28 renders an H bridge circuit using two half-bridge circuits each using the drive circuit of the first embodiment and the drive direction detection circuit 300 described in the fourth embodiment, and the input signal direction detection circuit described in the seventh embodiment.

The operating principle of this H bridge circuit duplicates the description of the H bridge circuit using the drive circuit of the first embodiment and the drive direction detection circuit 300 of the fourth embodiment, and further description thereof is thus omitted.

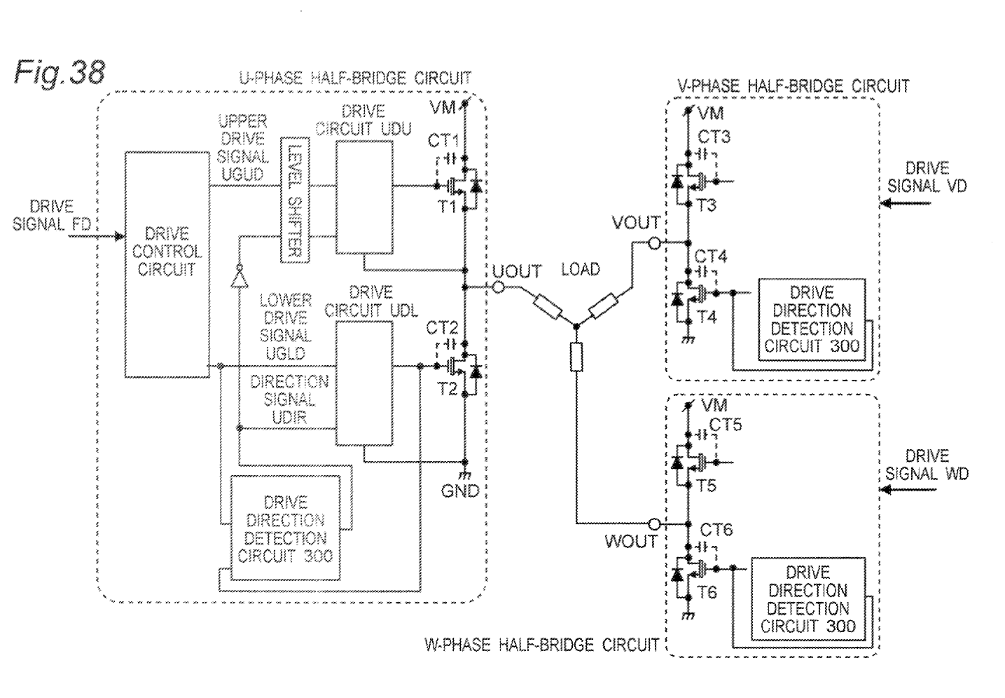

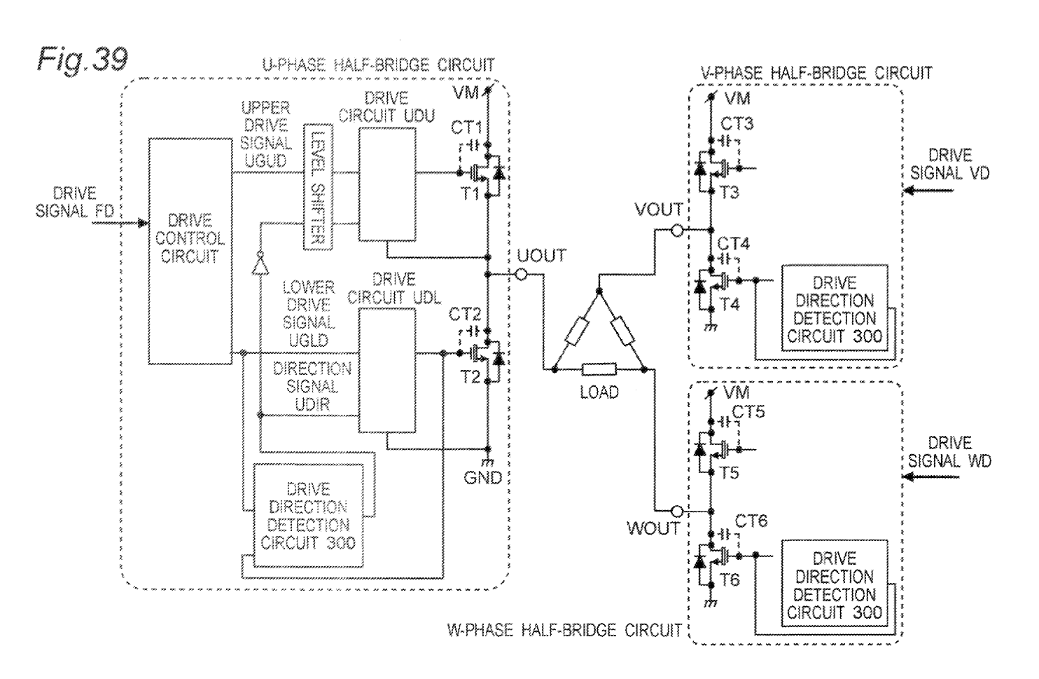

This tenth embodiment describes an H bridge circuit using the drive circuit of the first embodiment and the drive direction detection circuit 300 described in the fourth embodiment, but the ninth embodiment is not limited to an H bridge circuit and can be applied to a 3-phase inverter or multi-phase inverter as shown in FIG. 38 and FIG. 39.

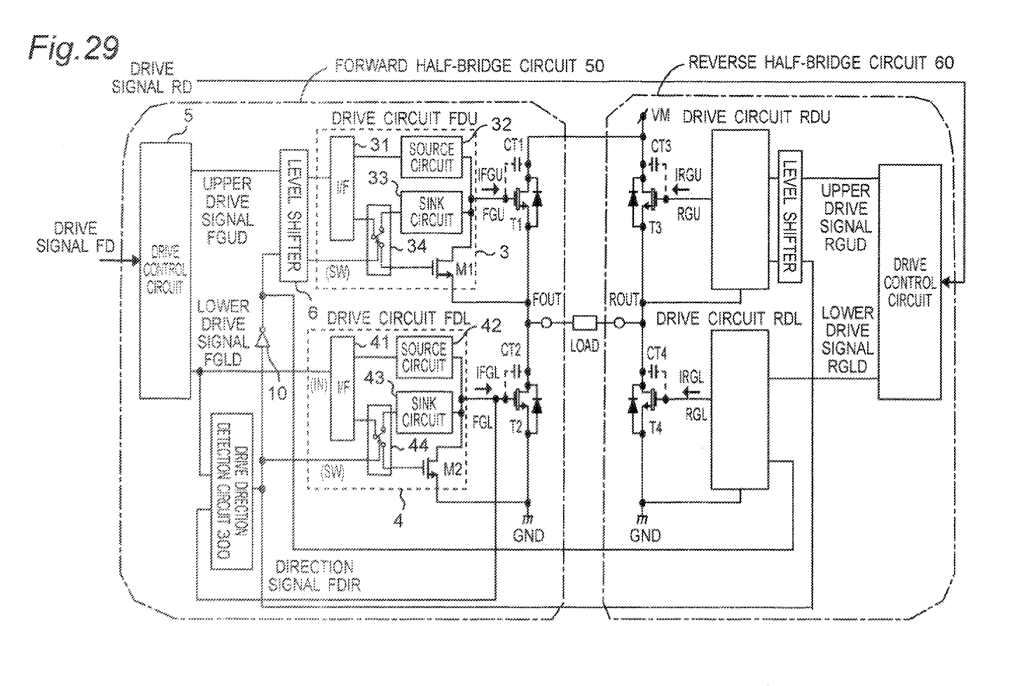

FIG. 29 shows another example of an H bridge circuit using the drive circuit of the first embodiment and the drive direction detection circuit 300 of the fourth embodiment. This configuration omits the drive direction detection circuit 300 in the reverse half-bridge circuit from the H bridge circuit configuration shown in FIG. 28. In an H bridge circuit the half-bridge circuits only have two phases, and if the load drive current direction of the half-bridge circuit in the forward half-bridge circuit for one phase can be determined, the load drive current direction of the half-bridge circuit for the half-bridge circuit on the reverse side is also known, and the drive direction detection circuit 300 can therefore be omitted from the reverse side circuit. A drive direction detection circuit 300 is needed in the half-bridge circuit of each phase in a 3-phase inverter or multi-phase inverter.

### Embodiment 11

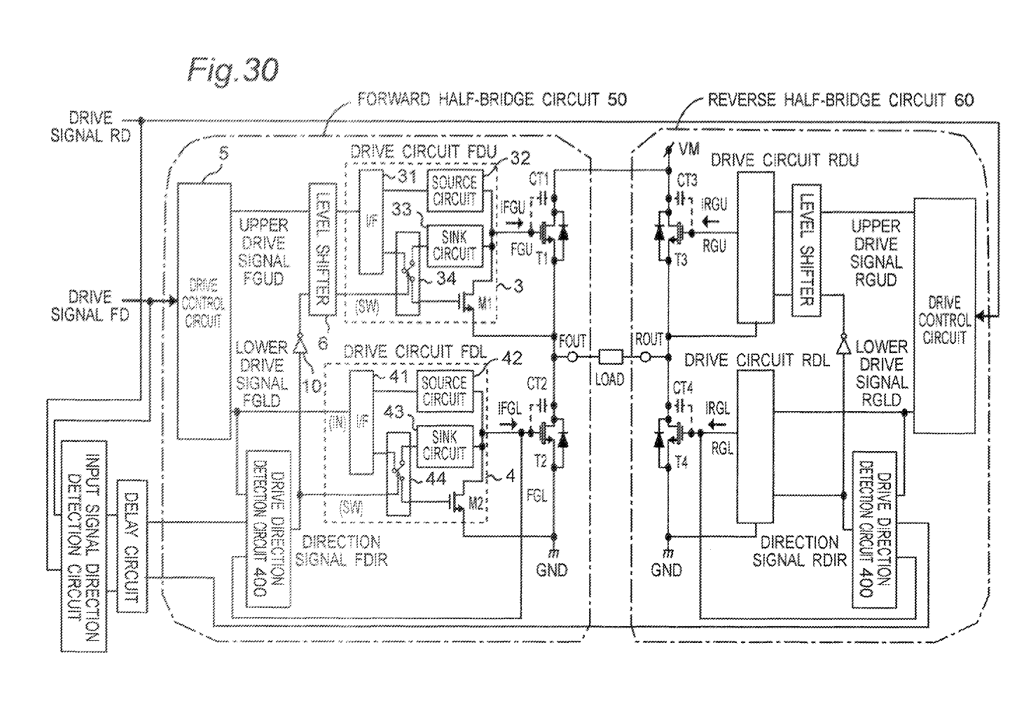

The eleventh embodiment shown in FIG. 30 renders an H bridge circuit using two half-bridge circuits each using the drive circuit of the first embodiment and the drive direction detection circuit 400 described in the fifth embodiment, and the input signal direction detection circuit described in the seventh embodiment.

The operating principle of this H bridge circuit duplicates the description of the half-bridge circuit in the fifth embodiment and the description of the H bridge circuit according to the seventh embodiment of the invention, and further description thereof is thus omitted.

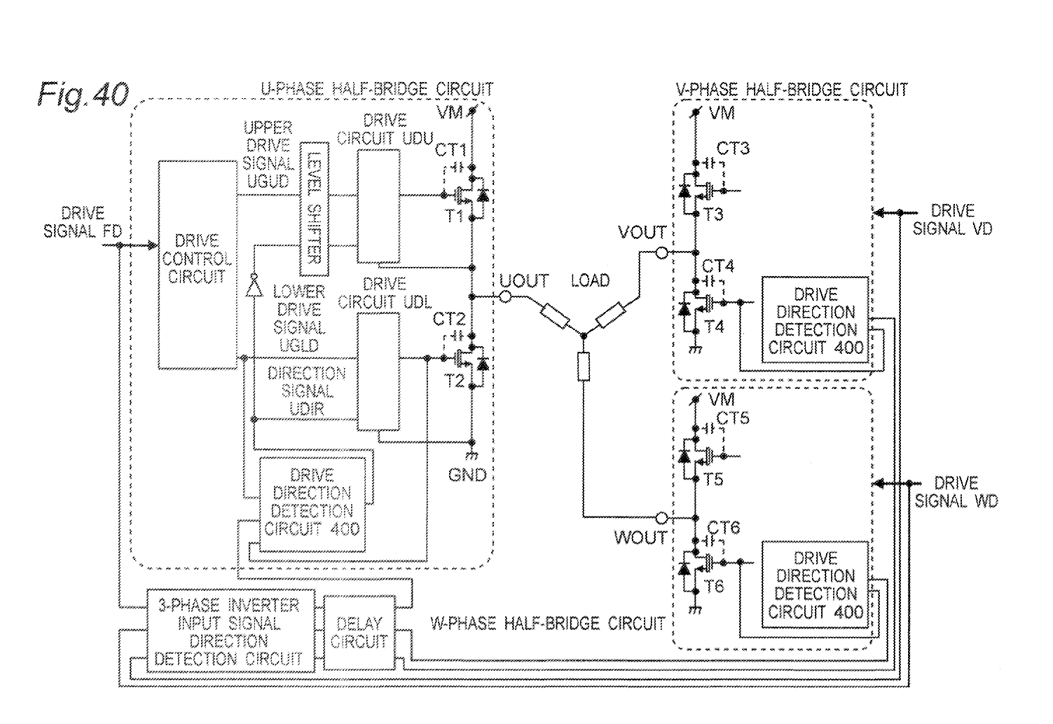

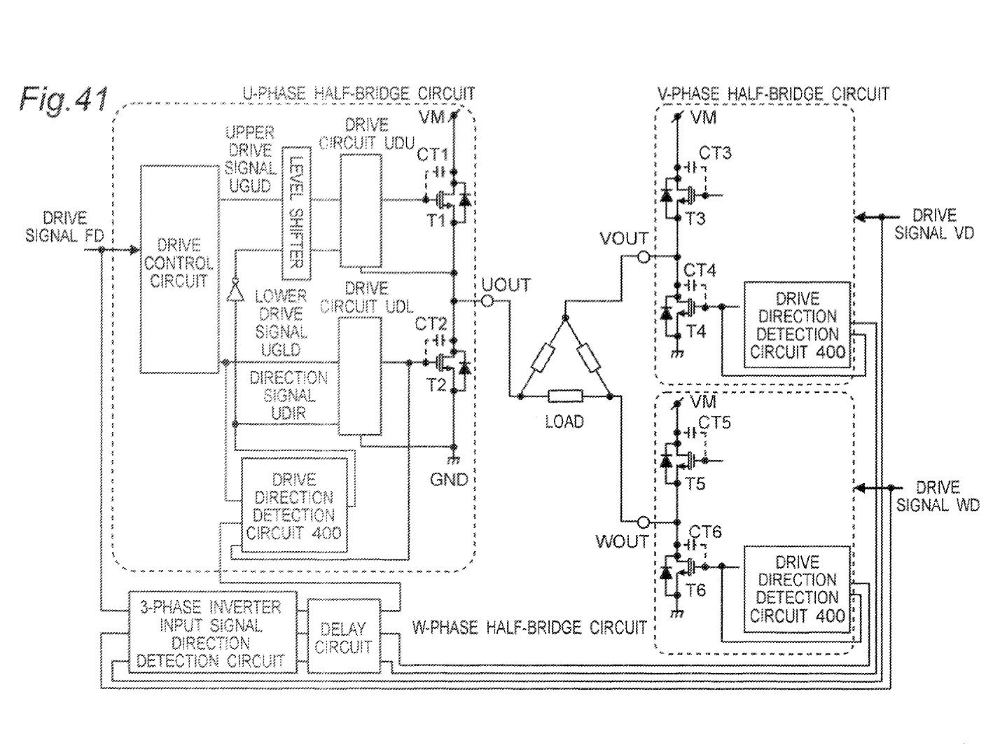

This eleventh embodiment describes an H bridge circuit using the drive circuit of the first embodiment and the drive direction detection circuit 400 described in the fifth embodiment, but the eleventh embodiment is not limited to an H bridge circuit and can be applied to a 3-phase inverter or multi-phase inverter as shown in FIG. 40 and FIG. 41.

### Embodiment 12

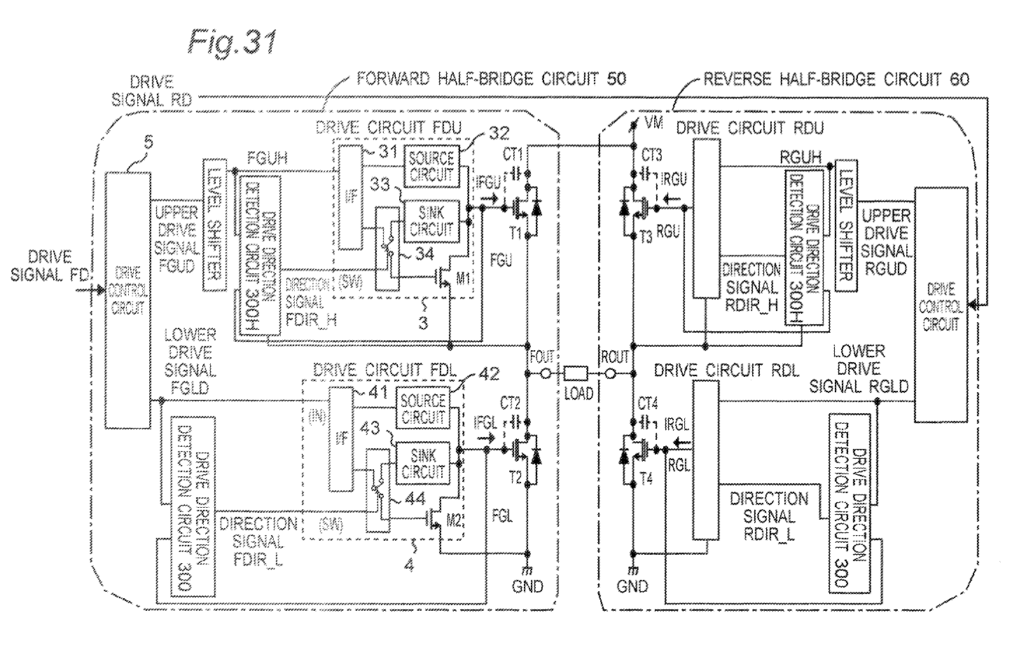

The twelfth embodiment shown in FIG. 31 renders an H bridge circuit using two half-bridge circuits each using the drive circuit of the first embodiment, and drive direction detection circuit 300 and drive direction detection circuit 300H described in the sixth embodiment.

The operating principle of this H bridge circuit duplicates the description of the half-bridge circuit of the sixth embodiment that uses the drive circuit of the first embodiment, the drive direction detection circuit 300 of the fourth embodiment, and drive direction detection circuit 300H, and further description thereof is thus omitted.

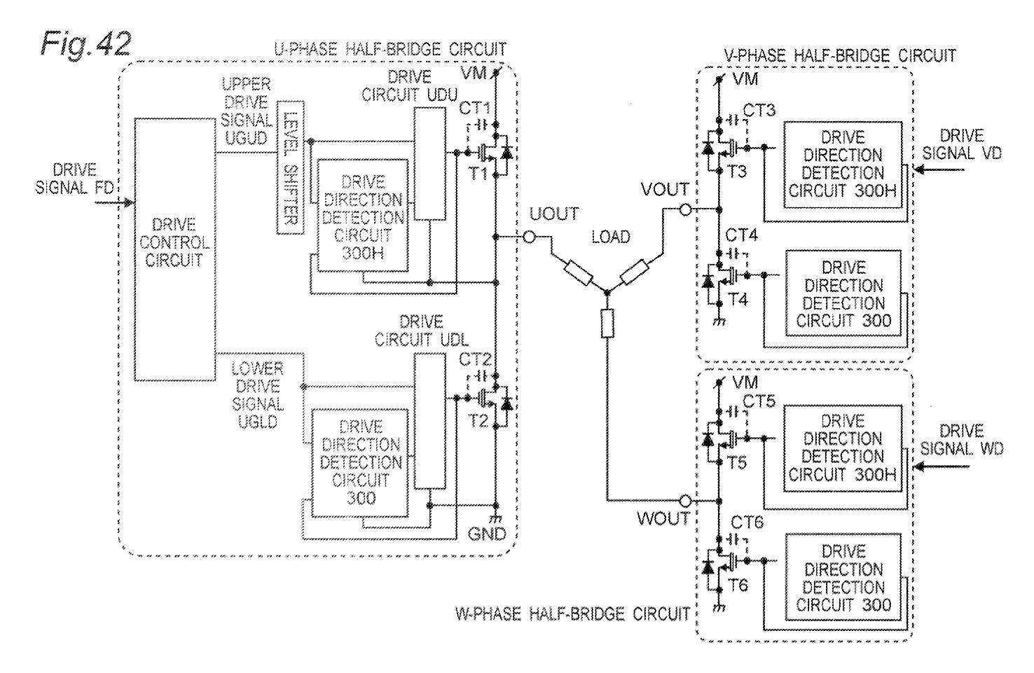

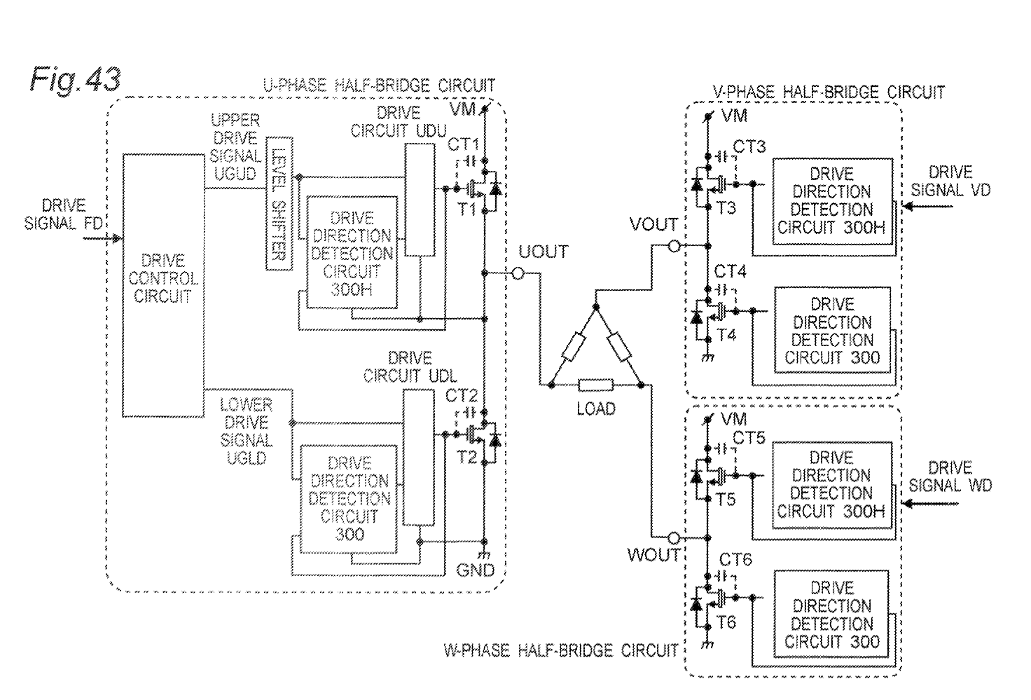

This twelfth embodiment describes an H bridge circuit using the drive circuit of the first embodiment and the drive direction detection circuit 300 and drive direction detection circuit 300H of the sixth embodiment, but the twelfth embodiment is not limited to an H bridge circuit and can be applied to a 3-phase inverter or multi-phase inverter as shown in FIG. 42 and FIG. 43.

### INDUSTRIAL APPLICABILITY

As described above, a drive device used in a semiconductor integrated circuit device according to the invention has a drive circuit for driving a switching device to the control terminal of which capacitive current flows during the off period of the switching device, and a drive direction detection circuit that determines the direction of the load current that the drive circuit drives. With this configuration, a half-bridge circuit using two switching devices, the drive circuit, and the drive direction detection circuit in combination can optimally adjust the electromagnetic interference level caused by change in the output voltage, can prevent a through mode (shoot-through or false firing), and is ideally suited to driving a load with switching devices.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. A drive circuit that drives a switching device having a control terminal to which capacitive current flows when the switching device is off, comprising:
an input terminal that receives a control signal that turns the switching device on or off;
a source circuit that SOURCE outputs a drive current to the control terminal of the switching device according to a first level or second level signal applied to the input terminal;
a sink circuit that SINK outputs a drive current to the control terminal of the switching device according to a second level or first level signal applied to the input terminal;
a current sink transistor that sinks capacitive current through the control terminal when the switching device is off;
an interface circuit that generates an input drive signal to the source circuit according to the input terminal signal, and an input drive signal to the sink circuit or the sink transistor;
a selector that selects whether to output the input drive signal to the sink circuit or to the sink transistor; and
an input terminal that receives a selection signal to the selector controlling this selection operation.

2. The drive circuit described in claim 1, wherein:
the selector sends a signal turning the sink transistor off when the input drive signal is output to the sink circuit, or sends a signal turning the sink circuit off or sends a signal continuously holding the sink circuit on when the input drive signal is output to the control terminal of the sink transistor.

3. The drive circuit described in claim 1, wherein:
the switching device is provided in plural, and the plurality of switching devices are arranged in any one of a half-bridge circuit, a H bridge circuit, and a three-phase inverter circuit.

4. The drive circuit described in claim 1, wherein:
the current sink transistor has a current capacity for receiving capacitive current flowing to the control terminal of the switching device.

5. A drive device comprising:
an upper switching device (T1) and lower switching device (T2) that control current supply to a load;
an upper drive circuit (DU) and lower drive circuit (DL) that respectively drive the upper switching device (T1) and lower switching device (T2);
a drive control circuit that generates an upper drive signal (GUD) that is input to the upper drive circuit (DU) to drive the upper switching device (T1), and generates a lower drive signal (GLD) that is input to the lower drive circuit (DL) to drive the lower switching device (T2);
a level shifter that sends the upper drive signal (GUD) to the upper drive circuit (DU);
a switching means that changes the direction of current to the load; and
an inverter that inverts the polarity of the direction signal from the switching means;
wherein the upper drive circuit (DU) has
an input terminal that receives a control signal that turns the upper switching device (T1) on or off,
an upper source circuit that SOURCE outputs a drive current to the control terminal of the upper switching device (T1) according to a first level or second level signal applied to the input terminal,
an upper sink circuit that SINK outputs a drive current to the control terminal of the upper switching device (T1) according to a second level or first level signal applied to the input terminal,
an upper sink transistor (M1) that sinks capacitive current through the control terminal when the upper switching device (T1) is off,
an upper interface circuit that generates a first input drive signal to the upper source circuit according to the input terminal signal, and a second input drive signal to the upper sink circuit or the upper sink transistor (M1), and
a selector that selectively supplies the second input drive signal to the upper sink circuit or the upper sink transistor based on a signal from the inverter; and
the lower drive circuit (DL) has
an input terminal that receives a control signal that turns the lower switching device (T2) on or off,
a lower source circuit that SOURCE outputs a drive current to the control terminal of the lower switching device (T2) according to a first level or second level signal applied to the input terminal,
a lower sink circuit that SINK outputs a drive current to the control terminal of the lower switching device (T2) according to a second level or first level signal applied to the input terminal,
a lower sink transistor (M2) that sinks capacitive current through the control terminal when the lower switching device (T2) is off,
a lower interface circuit that generates a first input drive signal to the lower source circuit according to the input terminal signal, and a second input drive signal to the lower sink circuit or the lower sink transistor (M2), and
a selector that selectively supplies the second input drive signal to the lower sink circuit or the lower sink transistor based on a signal from the switching means.

6. The drive device described in claim 5, further comprising:
a delay circuit that delays a direction signal from the switching means a specified time.

7. The drive device described in claim 5, further comprising:
a drive direction detection circuit having
a hysteresis comparator that detects if the output voltage to the load exceeds a specified threshold voltage,
a direction detection circuit that detects if the current flow to the load is forward or reverse using at least one of output to the comparator, the upper drive signal (GUD), and the lower drive signal (GLD), and outputs a first direction detection signal (LD) or a second direction detection signal (HD),
a first differential pulse circuit that detects one edge of the first direction detection signal (LD) and outputs a first pulse, or detects the other edge of the first direction detection signal (LD) and outputs a second pulse,
a second differential pulse circuit that detects one edge of the second direction detection signal (HD) and outputs a third pulse, and detects the other edge of the second direction detection signal (HD) and outputs a fourth pulse,
a pulse adder that combines the second pulse and the fourth pulse in a first OR output, and combines the first pulse and the third pulse in a second OR output; and
a flip-flop that sets or resets according to the output from the pulse adder.

8. The drive device described in claim 7, wherein:
the hysteresis comparator has a high threshold voltage and a low threshold voltage, outputs a first level when the output voltage to the load is greater than the high threshold voltage, and outputs a second level when the output voltage to the load goes below the low threshold voltage.

9. The drive device described in claim 7, wherein:
the output voltage to the load is detected downstream from the upper switching device T1 and the lower switching device T2.

10. The drive device described in claim 7, wherein:
the output voltage to the load is detected upstream from the upper switching device T1 and the lower switching device T2.

11. The drive device described in claim 7, further comprising:
a delay circuit that delays output from the hysteresis comparator a specific time.

12. The drive device described in claim 7, further comprising:
a third differential pulse circuit that detects one edge of the direction signal from the switching means and outputs a fifth pulse, and detects the other edge of the direction signal and outputs a sixth pulse, and
adds the fifth pulse to the second OR, and adds the sixth pulse to the first OR.

13. The drive device described in claim 7, wherein:
the drive direction detection circuit is provided in common to the upper drive circuit (DU) and the lower drive circuit (DL).

14. The drive device described in claim 7, wherein:
a drive direction detection circuit is provided for each of the upper drive circuit (DU) and the lower drive circuit (DL).

15. The drive device described in claim 5, wherein:
when current supply to the load is two phase, current supply is separately controlled to each phase.

16. The drive device described in claim 5, wherein:
when current supply to the load is three phase, current supply is separately controlled to each phase.
